(19) United States
(12) Patent Application Publication
(10) Pub. No.: US 2024/0088402 A1
(43) Pub. Date: Mar. 14, 2024

(54) Solid Oxide Cell

(71) Applicants: Phillips 66 Company, Houston, TX (US); Georgia Tech Research Corporation, Atlanta, GA (US)

(72) Inventors: Conor Evans, Harvest, AL (US); Meilin Liu, Alpharetta, GA (US); Ying Liu, Bartlesville, OK (US); Yucun Zhou, Atlanta, GA (US)

(21) Appl. No.: 18/346,038

(22) Filed: Jun. 30, 2023

Related U.S. Application Data
(60) Provisional application No. 63/374,296, filed on Sep. 1, 2022.

(51) Int. Cl. H01M 4/90; H01M 8/0656; H01M 8/1213; H01M 8/18; H01M 8/12

(52) U.S. Cl. CPC H01M 4/9033; H01M 8/0656; H01M 8/1213; H01M 8/186; H01M 2008/1293

(57) ABSTRACT

A solid oxide cell (SOC) includes a fuel electrode, an oxygen electrode, and an electrolyte. In some embodiments, the solid oxide cell is a reversible proton conducting solid oxide cell (P-rSOC). In some embodiments, the oxygen electrode is a perovskite oxide material having a formula such as PrBa_{0.8}Ca_{0.2}Co₂O_{5+δ}, PrBa_{0.9}Co_{1.96}Nb_{0.04}O₅, PrBaCo_{1.6}Fc_{0.2}Nb_{0.2-x}O_{5+δ}, PrBa_{0.5}Sr_{0.5}Co_{1.5}Fe_{0.5}O_{5+δ} (PBSCF), or PrBaCo₂O_{5+δ} (PBC) and it is coated with a perovskite oxide catalyst such as PrCoO₃.

### STATEMENT REGARDING FEDERALLY SPONSORED RESEARCH OR DEVELOPMENT

This invention was made with government support under Award Number DE-FE0031975 awarded by the Department of Energy. The U.S. government has certain rights in the invention.

### TECHNICAL FIELD

This relates to solid oxide cells and particularly to reversible solid oxide cells (rSOCs) and/or solid oxide cells having a proton conducting electrolyte.

### BACKGROUND

The search for clean energy sources has become increasingly popular as the world's power demand continues to grow and fear of climate change spreads across the globe. Recent progress in solar cell research is pushing the cost of solar produced electric power low enough to be competitive with the cost of coal. Even as solar technology's efficiency improves, the intermittent availability of solar irradiation leaves an issue of energy conversion.

Clean energy alternatives such as wind, hydro, and solar energy can be used in tandem with an energy storage mechanism such as conventional oxygen ion conductor based reversible solid oxide cells (O-rSOCs) and those that use a proton conducting electrolyte layer (P-rSOCs). Although O-rSOCs and P-rSOCs offer the potential of efficient and clean energy storage and conversion, they suffer from a number of problems.

One problem holding back the use of these materials is the sluggish oxygen reduction reaction (ORR) and oxygen evolution reaction (OER) kinetics that take place at the air electrode. Another problem is that the air electrode, especially in a P-rSOCs, is subject to harsh environments (e.g., high concentration of steam and exposure to Cr contamination) that can cause significant degradation over time.

### GENERAL DESCRIPTION

A solid oxide cell (SOC) includes a fuel electrode, an oxygen electrode, and an electrolyte. The fuel electrode, the oxygen electrode, and/or the electrolyte can be made of materials that provide one or more of the following enhanced properties: (1) increased oxygen reduction reaction and/or oxygen evolution reaction rates, (2) increased resistance to degradation experienced under harsh conditions such as high humidity at the oxygen electrode and nickel coarsening at the fuel electrode, and/or (3) lower polarization resistance, especially in the presence of chromium contamination.

In some embodiments, the solid oxide cell is a reversible solid oxide cell (rSOC). The rSOC can exhibit one or more of the following enhanced properties: (1) increased power density when operated in fuel cell mode, (2) increased current density when operated in electrolysis mode, and/or (3) increased electrical efficiency in both fuel cell and electrolysis modes. In some embodiments, the solid oxide cell is a reversible proton conducting solid oxide cell (P-rSOC).

In some embodiments, a solid oxide cell includes any combination of one or more of the following: a fuel electrode; an oxygen electrode; and an electrolyte positioned between the fuel electrode and the oxygen electrode; wherein the oxygen electrode includes a perovskite oxide material coated with a catalyst; wherein the electrolyte is a proton conducting electrolyte; and wherein the solid oxide cell is a reversible solid oxide cell. In some embodiments, the catalyst includes Pr₁₋ₓCo_{1-y}O₃ where x and y are non-integer values between 0 and 1.

In some embodiments, the perovskite oxide material is a double perovskite oxide material. In some embodiments, the solid oxide cell electrode has a formula of Pr_{w}BaₓCa_{y}Co_{z}O_{5+δ} or Pr_{w}BaₓCo_{y}Nb_{z}O_{5+δ} where w+x+y+z=approximately 4. In some embodiments, the solid oxide cell has a peak power density of at least 1.6 W/cm2 at 650° C. in fuel cell mode. In some embodiments, the solid oxide cell includes a single solid oxide cell where the absolute value of a current density is at least 2.9 A/cm2 at 1.3 V and 650° C. in electrolysis mode. In some embodiments, the oxygen electrode is configured to operate in electrolysis mode for at least 250 hours and experience negligible degradation.

In some embodiments, the electrolyte has a formula of ABO_{3+δ} where one or more alkaline earth metals are in the A sites and one or more transition metals or rare earth metals are in the B sites. In some embodiments, the electrolyte has a formula of BaZr_{w}CeₓY_{y}Yb_{z}O_{3-δ} where w+x+y+z=approximately 0.75 to approximately 1.

In some embodiments, a solid oxide cell includes any combination of one or more of the following: a fuel electrode; an oxygen electrode having a formula of Pr_{w}BaₓCa_{y}Co_{z}O_{5+δ} or Pr_{w}BaₓCo_{y}Nb_{z}O_{5+δ} where w+x+y+z=approximately 4; and an electrolyte positioned between the fuel electrode and the oxygen electrode; wherein the oxygen electrode is coated with a catalyst. In some embodiments, the catalyst includes Pr₁₋ₓCo_{1-y}O₃ where x and y are non-integer values between 0 and 1.

In some embodiments, the solid oxide cell is a reversible solid oxide cell. In some embodiments, the electrolyte is a proton conducting electrolyte. In some embodiments, the electrolyte has a formula of BaZr_{w}CeₓY_{y}Yb_{z}O_{3-δ} where w+x+y+z=approximately 0.75 to approximately 1.

In some embodiments, a method includes any combination of one or more of the following: infiltrating a solid oxide cell (SOC) electrode with a first solution including a catalyst to form a first infiltrated material; heating the first infiltrated material to form a dry SOC material; infiltrating the dry SOC material with a final solution including a catalyst to form a final infiltrated material; and heating the final infiltrated material to form an infiltrated solid oxide cell electrode. In some embodiments, the catalyst includes Pr₁₋ₓCo_{1-y}O₃ where x and y are non-integer values between 0 and 1.

In some embodiments, the solid oxide cell electrode has a formula of Pr_{w}BaₓCa_{y}Co_{z}O_{5+δ} or Pr_{w}BaₓCo_{y}Nb_{z}O_{5+δ} where w+x+y+z=approximately 4. In some embodiments, the first infiltrated material is positioned in a heated environment having a temperature of at least approximately 100° C. In some embodiments, the final infiltrated material is positioned in a heated environment having a temperature of at least approximately 500° C.

In some embodiments, a method includes any combination of one or more of the following: infiltrating a solid oxide cell electrode with a catalyst, the solid oxide cell electrode including a double perovskite oxide material; wherein the double perovskite oxide material includes praseodymium, barium, and cobalt.

In some embodiments, the catalyst includes Pr₁₋ₓCo_{1-y}O₃ where x and y are non-integer values between 0 and 1. In some embodiments, the double perovskite oxide material has a formula of: PrBaₓCa_{y}Co₂O_{5+δ} where x+y=approximately 1; or PrBaₓCo_{y}Nb_{z}O_{5+δ} where x=0.75 to 1 and y+z=approximately 1. In some embodiments, the double perovskite oxide material has a formula of PrBa_{0.8}Ca_{0.2}Co₂O_{5+δ} or PrBa_{0.9}Co_{1.96}Nb_{0.04}O₅.

The general description is provided to give a general introduction to the described subject matter as well as a synopsis of some of the technological improvements and/or advantages it provides. The general description and background are not intended to identify essential aspects of the described subject matter, nor should they be used to constrict or limit the scope of the claims. For example, the scope of the claims should not be limited based on whether the recited subject matter includes any or all aspects noted in the general description and/or addresses any of the issues noted in the background.

### DESCRIPTION OF DRAWINGS

The preferred and other embodiments are described in association with the accompanying drawings in which:

FIG. 1 is a perspective view of one embodiment of a solid oxide cell (SOC).

FIG. 2 shows one embodiment of a proton conducting reversible solid oxide cell (P-rSOC) that can selectively operate as a solid oxide fuel cell (SOFC) or a solid oxide electrolysis cell (SOEC).

FIG. 3 is an X-ray powder diffractogram of one embodiment of PBCC powder.

FIG. 4 is an X-ray powder diffractogram of one embodiment of PCO powder.

FIG. 5 is an x50k magnification SEM imaging of (a) bare PBCC cells and (b) PCO infiltrated PBCC cells.

FIG. 6 is a graph of the activation energy of PBCC cells infiltrated with 0.2 M PCO and bare PBCC cells.

FIG. 7 is a graph of polarization resistance v time using variable steam with various Cr sources using PBCC cells and PCO-PBCC cells.

FIG. 8 shows ×50k magnification SEM images of (a) bare PBCC cells and (b) PCO infiltrated PBCC cells exposed to variable steam for 650+ hrs using Crofer 22 APU interconnect as Cr introduction method.

FIG. 9 shows ×50k magnification SEM images of (a) bare PBCC cells and (b) PCO infiltrated PBCC cells exposed to variable steam for 650+ hrs using uncoated SS430 interconnect material as Cr introduction method.

FIG. 10 shows ×50k magnification SEM images of (a) bare PBCC cells and (b) PCO infiltrated PBCC cells exposed to variable steam for 650+ hrs using Mn_{1.5}Co_{1.5}O₄(MCO) coated SS430 interconnect material as Cr introduction method.

FIG. 11 is a graph showing the results of a Raman spectroscopy analysis of all cells tested in the variable steam test against various Cr sources.

FIG. 12A shows an EIS plot of bare PBCC single cells taken at 500° C. and 550° C.

FIG. 12B shows an EIS plot of bare PBCC single cells taken at 600° C. and 650° C.

FIG. 13A shows an EIS plot of PCO-PBCC single cells taken at 500° C. and 550° C.

FIG. 13B shows an EIS plot of PCO-PBCC single cells taken at 600° C. and 650° C.

FIG. 14 is a graph of ohmic and polarization resistances of PCO-PBCC and bare PBCC single cells taken from EIS data at various temperatures.

FIG. 15 is a graph of typical I-V-P curves for the bare PBCC single cell at various temperatures.

FIG. 16 is a graph of typical I-V-P curves for the PCO-PBCC single cell at various temperatures.

FIG. 17 is a graph comparing peak power densities of PCO-PBCC and bare PBCC with leading conventional protonic conducting SOCs

FIG. 18 is a graph of typical I-V curves measured at 600° C. and 650° C. for bare and PCO-PBCC single cells when run in SOEC mode.

FIG. 19 is a graph showing the stability of the PCO infiltrated single cell in electrolysis mode for 250 hrs.

FIG. 20 shows SEM images of the single cell (a) showing a ×3k magnification of the air electrode triple phase boundary and (b) showing a ×1k magnification of all layers of the functional cell.

FIG. 21 shows ×15k magnification SEM images of (a) Bare PBCC and (b) PCO-PBCC from the single cells after short term (250 h) testing.

FIG. 22 shows ×50k magnification SEM images of (a) Bare PBCC and (b) PCO-PBCC from the single cells after short term (250 h) testing.

### DETAILED DESCRIPTION OF EMBODIMENTS

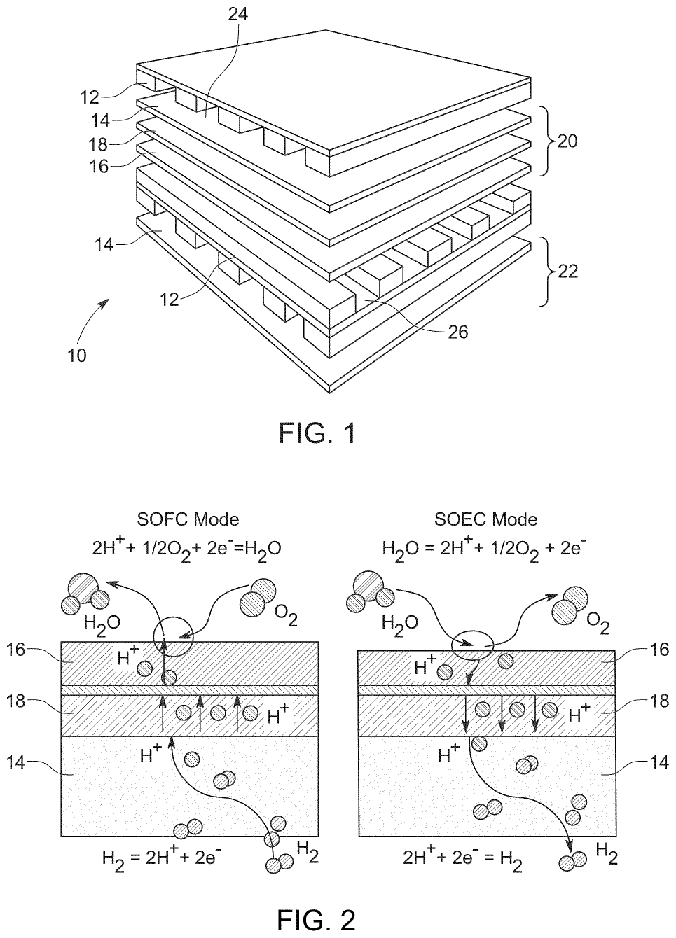

FIG. 1 shows one embodiment of a solid oxide cell (SOC) stack 10 including electrical interconnects 12, a fuel electrode 14, an oxygen electrode 16, and an electrolyte 18. The interconnects 12 are used to combine repeating units 22 of single solid oxide cells 20 to create a stack of solid oxide cells. The interconnects 12 include fuel gas passages 24 and oxygen passages 26 through which fuel gas and oxygen can flow. In some embodiments, air is the source of oxygen and the oxygen electrode 16 can be referred to as the air electrode.

The SOC 20 can be any type of solid oxide cell and have a variety of configurations. For example, the SOC 20 can be an oxygen ion solid oxide fuel cell (O-SOFC), an oxygen ion solid oxide electrolysis cell (O-SOEC), an oxygen ion reversible solid oxide cell (O-rSOC), a proton conducting solid oxide fuel cell (P-SOFC), proton conducting solid oxide electrolysis cell (P-SOEC), or a proton conducting reversible solid oxide cell (P-rSOC). The SOC 20 can also be a symmetrical solid oxide cell where the fuel electrode 14 and the oxygen electrode 16 have the same compositions or a non-symmetrical solid oxide cell where the fuel electrode 14 and the oxygen electrode 16 have different compositions. Furthermore, the SOC can be planar or tubular shape.

FIG. 2 shows one embodiment of a P-rSOC comprising the fuel electrode 14, the oxygen electrode 16, and the electrolyte 18. The P-rSOC can be operated alternatively as a solid oxide fuel cell (SOFC) or a solid oxide electrolysis cell (SOEC). When operated in fuel cell mode, the P-rSOC is capable of oxidizing one or more gaseous fuels to produce electricity and heat. When operated in electrolysis mode, the P-rSOC can consume electricity and heat to convert the products of the reduction reaction into gaseous fuel. The gaseous fuel can be pressurized and stored for later use. For this reason, P-rSOCs are especially suitable for use as a clean energy storage solution.

As shown in FIG. 2, the electrolyte 18 in the P-rSOC conducts protons from the fuel electrode 14 to the oxygen electrode 16 when the P-rSOC is operated in fuel cell mode and conducts protons from the oxygen electrode 16 to the fuel electrode 14 when operated in electrolysis mode.

The described materials, methods, and other technologies are especially applicable to P-rSOCs such as that shown in FIG. 2. In general, P-rSOCs have better ionic conduction and accelerated electrode reaction kinetics at lower temperatures than a standard oxide conducting based rSOCs. The lowered temperature of operation means P-rSOCs experience slower cell degradation, less interlayer diffusion and can be constructed from a larger possible selection of materials. In P-rSOCs, the water formation and consumption during cell operation in fuel cell mode and electrolysis cell mode occur solely at the oxygen electrode. This reduces system complexity and consequently cost because the fuel does not need to undergo any treatment or purification when switching between fuel and electrolysis modes causing the fuel to remain undiluted. The lower temperature at which P-rSOCs operate allows for lower costs associated with operation and less degradation of materials.

Although P-rSOCs are associated with the above advantages, they also have some disadvantages. The lower temperature means the kinetics of the oxygen reduction reaction (ORR) and oxygen evolution reactions (OER) are drastically decreased, significantly increasing the cell's polarization resistance (Rₚ). The lowered kinetics restrict the type of material that can be used for an oxygen electrode 16 due to insufficient catalytic activity. The oxygen electrode 16 material selection is further restricted due to the high humidity the oxygen electrode 16 is subjected to during operation. The disadvantages can be reduced or minimized by modifying the electrodes 14, 16, especially the oxygen electrode 16 to enhance its performance. For example, the electrodes 14, 16 can be coated with a catalyst to enhance performance.

Electrolyte

The electrolyte 18 serves a number of purposes in the SOC. First and foremost, it is used to conduct ions between the electrodes 14, 16, preferably at lower temperatures. It can also separate the reacting gases present at the electrodes 14, 16. It can also have a low electronic conductivity to prevent losses from leakage currents. It can also force electron flow through the external circuit.

In some embodiments, the electrolyte 18 has one or more of the following properties: (1) ionic conductivity sufficient for efficient operation of the SOC, (2) dimensional stability (e.g., cubic structure, etc.) and thermal expansion properties that are compatible with the electrodes 14, 16 and other SOC materials, (3) chemical stability against high oxidizing and reducing environments during operation, (4) high density to prevent mixing of reducing and oxidizing gases (whereas the electrodes 14, 16 should be porous for gas transport), (5) high electronic resistivity (e.g., nearly no electronic conductivity; an ionic transference number close to one), (6) excellent thermal and shock resistant, (7) easily available, low cost, and durable, and (8) capable of being formed as a thin layer such as 30 microns or less.

In some embodiments, the electrolyte 18 is a proton conducting electrolyte. The proton conducting electrolyte can have a proton conductivity of at least 10⁻⁴ S/cm, at least 10⁻³ S/cm, or preferably at least 10⁻² S/cm at the operating temperature—e.g., 500-600° C.

In some embodiments, the proton conducting electrolyte 18 is a perovskite oxide material. It can be a single perovskite oxide material, a double perovskite oxide material, or a layered perovskite oxide material. In some embodiments, the proton conducting electrolyte 18 is a single perovskite oxide material having a formula of ABO_{3+δ} where one or more alkaline earth metals are in the A sites and one or more transition metals or rare earth metals are in the B sites.

In some embodiments, the proton conducting electrolyte 18 has a formula of BaZr_{w}CeₓY_{y}Yb_{z}O_{3-δ} where w+x+y+z=approximately 0.75 to approximately 1. In some embodiments, the proton conducting electrolyte 18 has a formula of BaZr_{0.1}Ce_{0.7}Y_{0.1}Yb_{0.1}O_{3-δ} (BZCYYb). In some embodiments, the proton conducting electrolyte 18 has a formula of BaHfₓCe_{0.8-x}Y_{0.1}Yb_{0.1}O_{3-δ} (BHCYYb) where the index x is from about 0.1 to about 0.5. In some embodiments, the proton conducting electrolyte 18 has a formula of BaMₓCe_{1-x-y}R_{y}O_{3-δ} where M is niobium or tantalum; R is one or more metals having a valence of 3+. Nonlimiting examples of metals having a 3+ valence include ytterbium, yttrium, dysprosium, scandium, vanadium, chromium, iron, cobalt, lutetium, holmium, terbium and the like. The index x is from 0 to 1. The sum of the individual y indices is from 0 to 1.

Electrodes

It should be appreciated that the electrodes 14, 16 can be made of or include any suitable material. The electrodes 14, 16 are sintered at high temperatures to form a porous scaffold, provide a good bond with the electrolyte 18, and form an effective bridge between the particles for effective electron and ion conduction. The electrodes 14, 16 can be chosen based on one or more of the following: (1) their high electrical conductivity, (2) thermal expansion that corresponds to that of the adjoining components, (3) the ability to avoid coke deposition for fuel electrode 14, (4) chemical compatibility with other SOC components, (e.g., electrolyte 18 and interconnects 12) at operating temperature, (5) large triple phase boundary, (6) high electrochemical activity for the reacting gas, and (7) high porosity (30-50%) for adequate gas flow, good electronic and ionic conductive phases.

In some embodiments, the electrodes 14, 16 include one or more perovskite oxide materials. In general, these are oxide materials having a perovskite structure—e.g., single perovskite structure that has the general formula of ABO₃ where A and B are cations occupying the A and B sites of the crystal structure, double perovskite structure that has a unit cell twice that of a single perovskite, or layered perovskite structure that has multiple slabs of the ABO₃ structure separated by one or more motifs. These can be referred to as single perovskite oxide materials, double perovskite oxide materials, or layered perovskite oxide materials.

It should be appreciated that the electrodes 14, 16 can be made of the same material or of different materials. For example, one of the electrodes 14, 16 can be made of alkaline earth metals, transition metals, and/or rare earth metals. Likewise, the A and B sites can individually be a single one of these elements or one of these elements doped with one or more additional ones of these elements.

In some embodiments, the electrodes 14, 16, but especially the oxygen electrode 16 in a P-rSOC includes a perovskite oxide material including a rare earth metal, an alkaline earth metal, and a transition metal. In some embodiments, the perovskite oxide material is a double perovskite oxide material. In some embodiments, the perovskite oxide material includes praseodymium, barium, and cobalt. In some embodiments, the perovskite oxide material also includes at least one of calcium or niobium.

In some embodiments, the perovskite oxide material has a formula of Pr_{w}BaₓCa_{y}Co_{z}O_{5+δ} or Pr_{w}BaₓCo_{y}Nb_{z}O_{5+δ} where w+x+y+z=approximately 4. In some embodiments, the perovskite oxide material has a formula of PrBaₓCa_{y}Co₂O_{5+δ} where x+y=approximately 1 or PrBaₓCo_{y}Nb_{z}O_{5+δ} where x=approximately 0.75 to approximately 1 and y+z=approximately 1. In some embodiments, the perovskite oxide material has a formula of PrBa_{0.8}Ca_{0.2}Co₂O_{5+δ} (PBCC), PrBa_{0.9}Co_{1.96}Nb_{0.04}O₅ (PB9CN), PrBaCo_{1.6}Fe_{0.2}Nb_{0.2-x}O_{5+δ}, PrBa_{0.5}Sr_{0.5}Co_{1.5}Fe_{0.5}O_{5+δ} (PBSCF), or PrBaCo₂O_{5+δ} (PBC).

Notably, PBCC is a double perovskite oxide material that demonstrates high ORR activity and excellent durability. It is resistant to CO₂-containing air, which is present in many ambient air sources for solid oxide cell operation. A PBCC oxygen electrode 16 is also highly resistant to up to 50% humidity for over 1000 hours of cell operation. High steam environments do not change the I-V curves of cells when run in electrolysis mode, thus suggesting that high steam pressures have little impact on cell performance. PBCC also has high Faraday efficiency in high steam. This inherent stability in both high steam and CO₂ environments makes PBCC an attractive oxygen electrode material for use in P-rSOCs.

Perovskite oxide materials such as PBCC often suffer from stability issues at the surface due to cation segregation. Ba is an A-site cation in PBCC's perovskite structure. The A-site cations are required for the formation of layered lattice stacking and are known to be among the most mobile cations. Their mobility can break down the initial crystal structure through segregation, volatilization, and phase transition of the cation. For PBCC, the segregation causes the formation of BaO on the surface of the structure, which can react with Cr contaminates present in the cell operation environment. The contaminants originate from the interconnect material of the cell stack. The amount of chromium species present is heavily exacerbated by a high steam content. The reaction between BaO and Cr species will readily cause the formation of BaCrO₄, which acts as an insulating layer and can be catastrophic to the performance and efficiency of a cell.

Catalyst

The electrodes 14, 16 can be infiltrated or impregnated with the catalyst or other material to enhance the performance of the electrodes 14, 16 and/or the performance of the overall solid oxide cell. For example, solution infiltration offers an inexpensive method to form a thin film or particle deposition coating on perovskite oxide materials such as PBCC that can shield the oxygen electrode backbone from harsh high steam environments. The infiltration can also limit sites where Cr contaminates can react with segregated ions.

It should be appreciated that any suitable material or combination of materials can be used as the catalyst. In some embodiments, the catalyst is a perovskite oxide material such as a single perovskite oxide material having a formula of ABO₃. In some embodiments, the single perovskite oxide material can include praseodymium and cobalt. In some embodiments, the catalyst is Pr₁₋ₓCo_{1-y}O₃ where x and y are, independently, non-integer values between 0-1. In some embodiments, the catalyst includes PrCoO₃. In other embodiments, the catalyst can include one or more of La_{0.6}Sr_{0.4}Co_{0.2}Fe_{0.8}O₃(LSCF), La_{0.6}Sr_{0.4}CoO₃ (LSC), Pr_{0.6}Sr_{0.4}CoO₃, Sm_{0.5}Sr_{0.5}CoO₃₋ₓ (SSC), LaNiO₃, BaCoO₃, LaNi_{0.6}Fe_{0.4}O₃, or Pr_{0.5}Ba_{0.5}CoO₃₋ₓ.

In some embodiments, the oxygen electrode 16 is infiltrated with a PrCoO₃ solution to promote a lower polarization resistance and Cr resistance and increase the power density.

Catalyst Infiltration

The infiltration process involves the deposition of catalyst nanoparticles in the porous scaffold of the sintered electrodes 14, 16. The electrodes 14, 16 can be infiltrated with the catalyst using any suitable methods. For example, the electrodes 14, 16 can be infiltrated with the catalyst before or after formation of the solid oxide cell. It should be appreciated that one or both of the electrodes 14, 16 can be infiltrated with the catalyst. For example, in some embodiments only the oxygen electrode 16 is infiltrated with the catalyst. In other embodiments, only the fuel electrode 14 is infiltrated with the catalyst. In other embodiments, both the fuel electrode 14 and the oxygen electrode 16 are infiltrated with the catalyst.

The infiltration process can include infiltrating the electrodes 14, 16 with a liquid solution including the catalyst precursors and drying the electrodes 14, 16 in a heated environment. The electrodes 14, 16 can be infiltrated with the liquid solution and dried multiple times to coat the porous scaffold of the electrodes 14, 16 more fully. In some embodiments, the electrodes 14, 16 can be repeatedly infiltrated with the liquid solution and dried. In various embodiments, infiltration and drying can be performed at least one time, at least two times, at least three times, at least four times, or more. The liquid solution used for each infiltration step can be the same or different than the liquid solution used in a previous or subsequent infiltration step—i.e., any combination of the same or different liquid solutions can be used each time the electrodes 14, 16 are infiltrated. A vacuum and/or desiccator can be applied to facilitate distribution of the liquid solution and/or solvent evaporation at any one or more of the infiltrations.

The liquid solution can include a solvent and one or more catalysts. The solvent can be a single material or combination of materials capable of solubilizing the one or more catalysts. Examples of suitable solvents include deionized water, isopropyl alcohol, ethanol, i-propanol, n-propanol, ethylene glycol, 1,3-propanediol, 2-methoxy ethanol, and/or acetic acid. The catalyst can be any of those described above.

The electrodes 14, 16 can be dried in any suitable manner and using any suitable conditions. In some embodiments, the electrodes 14, 16 are dried by being positioned in a heated environment having a temperature of at least approximately 100° C., at least approximately 200° C., or at least approximately 300° C. In other embodiments, the electrodes 14, 16 are dried by being positioned in a heated environment having a temperature of approximately 100° C. to approximately 700° C., approximately 200° C. to approximately 600° C., or approximately 300° C. to approximately 500° C.

In some embodiments, the electrodes 14, 16 are dried by being positioned in a heated environment having a temperature of at least approximately 500° C., at least approximately 600° C., or at least approximately 700° C. In other embodiments, the electrodes 14, 16 are dried by being positioned in a heated environment having a temperature of approximately 500° C. to approximately 1100° C., approximately 600° C. to approximately 1000° C., or approximately 700° C. to approximately 900° C.

In some embodiments, the electrodes 14, 16 are dried at one temperature for one or more infiltration steps and dried at a different temperature for one or more other infiltration steps. For example, the electrodes 14, 16 can be dried at a lower temperature initially (e.g., the first one, two, or three infiltration steps) and then dried at a higher temperature later (e.g., the last one, two or three infiltration steps).

In some embodiments, the electrodes 14, 16 are positioned in the heated environment for at least approximately 20 minutes, at least approximately 30 minutes, at least approximately 40 minutes, or at least approximately 50 minutes to form the dry SOC material. In other embodiments, the electrodes 14, 16 are positioned in the heated environment for at least approximately 80 minutes, at least approximately 90 minutes, at least approximately 100 minutes, or at least approximately 110 minutes.

In some embodiments, the electrodes 14, 16 are dried by being positioned in an environment that is heated to any of the above temperatures at a rate of at least approximately 1° C./min, at least approximately 1.5° C./min, at least approximately 1.7° C./min, or at least approximately 1.9° C./min. In other embodiments, the electrodes 14, 16 are dried by being positioned in an environment that is heated to any of the above temperatures at a rate of approximately 1° C./min to approximately 10° C./min, approximately 1.5° C./min to approximately 6° C./min, approximately 1.7° C./min to approximately 4° C./min, or approximately 1.9° C./min to approximately 3° C./min. In other embodiments, the electrodes 14, 16 are dried by being positioned in an environment that is heated to any of the above temperatures at a rate of no more than approximately 10° C./min, no more than approximately 6° C./min, no more than approximately 4° C./min, or no more than approximately 3° C./min.

It should be appreciated that for processes involving repeated infiltration and drying of the electrodes 14, 16, any of the conditions above can be applied to any drying step.

### EXAMPLES

The following examples are provided to further illustrate the disclosed subject matter. They should not be used to constrict or limit the scope of the claims in any way.

### Example 1—PBCC Powder Preparation

PrBa_{0.8}Ca_{0.2}Co₂O_{5+δ} (PBCC) powder was synthesized by the EDTA-CA method. Stoichiometric amounts of metal nitrates were mixed with ethylenediaminetetraacetic acid (EDTA) (ACS reagent, 99.5% purity) and citric acid (CA) (ACS reagent, 99.5% purity). The molar ratio between the metal ions, EDTA, and CA was 1:1:1.5. The nitrates used for synthesis were calcium nitrate tetrahydrate (ACS reagent, 99% purity), cobalt(II) nitrate hexahydrate (ACS reagent 98% purity), and barium nitrate (ACS reagent, 99% purity), all from Sigma-Aldrich and praseodymium(III) nitrate hydrate (REO, 99.9%), which was from Alfa Aesar.

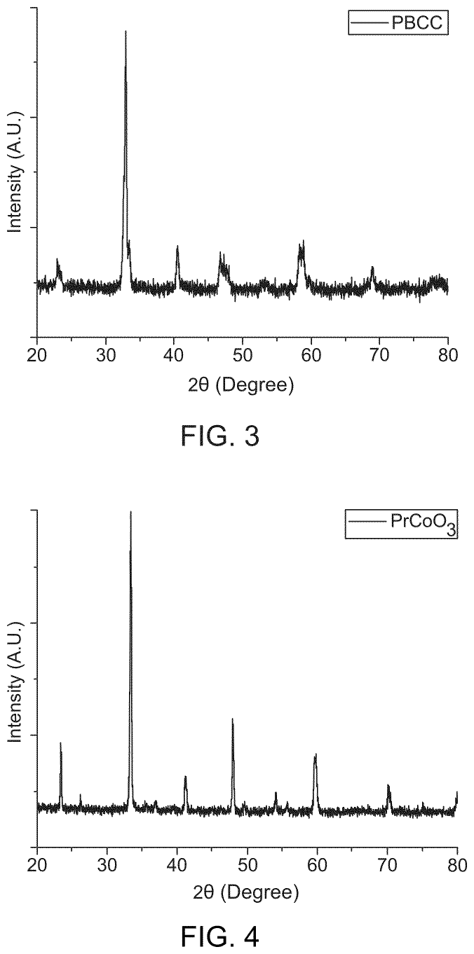

The nitrates were dissolved in deionized water with a stir bar. Ammonium hydroxide (ACS, 28-30%) was then used to adjust the pH to 7. A hot plate was used to heat the solution for 36 hrs at 100° C. with continuous stirring from a stir bar to ensure the nitrates were completely dissolved. The gel that remained was calcined at 300° C. for 10 hrs. The primary powder was then ground and calcined at 600° C. for 5 hrs. Finally, the powder was again ground into fine particle size and fired at 1000° C. for 2 hrs to form the desired phase. XRD (X-ray powder diffraction) was used to confirm that the double perovskite has been formed. The PBCC XRD results are shown in FIG. 3 and are consistent with previously reported PBCC XRD results.

### Example 2—PBCC Tape Fabrication

To fabricate the air electrode for the symmetrical cells, PBCC powder was tape cast to form thin PBCC electrode tapes. The mixture to make the slurry for this tape was ball milled in a small 30 mL bottle containing 30 5.5 mm zirconia balls. The mixture included the following:
7.5 grams PBCC
0.75 grams graphite (solid)
0.27 g fish oil
2.4 g of xylene
2.16 g of ethanol

The fish oil was obtained from The Tape Cast Warehouse while the graphite was obtained from Sigma Aldrich. The mixture was ball milled for 12 hr. After this, 0.495 g Polyalkylene glycol (PAG) was added to the mixture, and it was ball milled for an additional 12 hr. Next, 0.255 g of Butyl Benzyl Phthalate (BBP) was added, and the mixture was again ball milled for an additional 12 hr. Lastly, 0.465 g of Polyvinyl Butyral (PVB) was added, and the slurry was again ball milled for 12 hrs for a total of 48 hours of mixing to finish preparation of the PBCC slurry.

The slurry was degassed at 25 mm Hg for 20 min to remove accumulated air bubbles that could potentially cause defects in the tape. The tape casting blade was adjusted to the proper setting to yield a 50-micron thick tape after drying. The blade was calibrated by measuring the dried tape's thickness until a 50-micron tape was achieved. A mesh stainless steel screen was used to filter the zirconia balls from the slurry. The slurry was then deposited onto a Mylar carrier film behind the tape casting blade. The tape casting was done at 20% speed until the slurry had been fully deposited onto the Mylar film. The deposited tape was left for 14 hrs to dry completely. A cover was placed over the tape caster as a preventative measure against dust and other particles from contacting the slurry. Once dried, the tape was punched and 6 mm circles of tape were removed that were used for symmetrical cell application.

### Example 3—Fabrication of Dense Samarium Doped Ceria (SDC) Electrolyte

Commercial grade SDC-20-M (samarium doped ceria (20% Sm)) was obtained from Fuel Cell Materials. The SDC was ball milled for 48 hrs with 4 wt % Polyvinyl Butyral (PVB), obtained from Aldrich, and ethanol. Once mixed, the slurry was dried and ground to a fine enough size to pass through a 300-micron sieve. 0.23 grams of powder was pressed into a pellet using a 10 mm die press with 3 tons of force for 1 min. The pellets were then fired in a bed of SDC-20-M powder at:
Ramp: 1° C./min to 400° C.
Hold: 1 hour at 400° C.
Ramp: 2° C./min to 700° C.
Hold: 1 hour at 700° C.
Ramp: 3° C./min to 1450° C.
Hold: 5 hours at 1450° C.
Cool to 300° C. at 3° C./min

### Example 4—Fabrication of Symmetrical Cells

Sintered SDC pellets were cleaned with ethanol, and their surfaces were sanded until smooth. A pipette was used to deposit 15 microliters of an SDC buffer layer solution onto one side of the pellet. The SDC buffer layer solution included 1 g commercial SDC-20, 20 g acetone, and 4 g V006 ink vehicle electrical paste from Heraeus. The solution was left to continuously ball mill in a 30 ml container with 30 zirconia balls (5.5 mm). The buffer layer was applied and allowed to sit on the pellet surface for 3.5 min before a PBCC green tape was placed on the SDC pellet. This side of the pellet was then allowed to sit in ambient air for 5 min and was then brought to a drying oven to sit at 80° C. for 45 min. The process was repeated to the other side of the SDC pellet so that both sides had a PBCC electrode adhered. The PBCC tape was fully dried on the SDC before the symmetrical cell was fired. The cell was fired on an alumina sample holder that allows the two faces of the symmetrical cell to have access to air flow in the furnace. The cells were fired at:
Ramp: 1° C./min to 400° C.
Hold: 1 hr at 400° C.
Ramp: 2° C./min to 1080° C.
Hold: 2 hrs at 1080° C.
Cool to 50° C. at 3° C./min

The PBCC electrode layer thickness after firing was found to be about 30.6 microns using SEM imaging.

### Example 5—Fabrication of Single Cells

BaZr_{0.1}Ce_{0.7}Y_{0.1}Yb_{0.1}O_{3-δ} (BZCYYb) was used as the proton conducting electrolyte for single cell fabrication. The BZCYYb powder was synthesized using the solid-state reaction method. Stoichiometric amounts of barium carbonate, zirconium oxide, cerium oxide, yttrium oxide, and ytterbium oxide powders, all of which provided by Aldrich chemicals, were ball milled together at 400 rpm in ethanol for 4 hours. The powder was dried and calcined at 1100° C. for 12 hours in air.

Ni-BZCYYb fuel electrode supported half-cells were fabricated by a co-tape casting and sintering method. Specifically, the electrolyte powder and a mixture of BZCYYb and NiO powder (NiO:electrolyte powder=6:4 by weight) were mixed in a solvent to form their respective slurries. The slurries were ethanol based and contained a dispersing agent, binder, plasticizer, and other additives, in addition to powder. The BZCYYb electrolyte layer was tape cast onto a Mylar film first. After drying, the fuel electrode functional layer Ni-BZCYYb was cast on top of the electrolyte layer, followed by the fuel electrode supporting layer Ni-BZCYYb. After drying in ambient air for 12 hours, the tri-layer tapes were co-sintered at 1400° C. for 5 hours in air.

To fabricate the single button cells, the PBCC air electrode was prepared by screen-printing PBCC ink onto the electrolyte of the half-cell followed by sintering at 950° C. for 2 hours. The PBCC powder for the air electrode ink was prepared by the same methods previously described, with the exception that after the calcination at 600° C. for 5 h, the PBCC powder was fired at 900° C. for 2 hours, rather than at 1000° C. The ink for screen-printing was prepared by mixing the as-synthesized PBCC powder with binder (5% ethyl cellulose dissolved in terpineol). The PBCC air electrode had an effective area of 0.28 cm².

### Example 6—PrCoO₃ Infiltration

The PrCoO₃ (PCO) catalyst solution was introduced into the porous PBCC backbone by a solution infiltration method. The solution was prepared using stoichiometric amounts of praseodymium(III) nitrate hydrate (REO, 99.9%), which was from Alfa Aesar, and cobalt(II) nitrate hexahydrate (ACS reagent 98% purity) from Sigma Aldrich. These nitrate precursors were dissolved into deionized water to achieve a desired molarity of 0.2 M. In addition, 5 wt. % of polyvinylpyrrolidone (PVP), obtained from Sigma Aldrich, was added to the solution as a surfactant, and glycine, from Alfa Aesar, was used as a complexing agent. In this instance the 5 wt. % refers to the total weight of the nitrates salts before they were dissolved in solution. The molar ratio of glycine to NO₃⁻ was 1:1. The solution was dropped into the PBCC layer of the symmetrical or single cell and then dried in a drying oven. The cells were then fired at:
Ramp: 2° C./min to 800° C.
Hold: 2 hour at 800° C.
Cool to 50° C. at 3° C./min

### Example 7—Symmetrical Cell Testing Procedure

Alumina cell fixtures were used to hold the symmetrical cells in the furnace while testing. A silver wire current collector was placed on each side of the symmetrical cell. A chromium source was placed over each side of the symmetrical cell and SDC pellets were placed on either side of the Cr source. This testing configuration of a PBCC-SDC symmetrical cell, silver wire, a Cr source, and exterior SDC pellets made up the symmetrical cell testing “stack.” It was held in place using a thin alumina rod that applied light pressure to the stack via a spring at the top of the alumina cell fixture. Silver wire was run through the alumina cell fixture to connect to the silver wire current collector, which allowed for a connection to the cell to be made outside of the testing furnace. When steam and/or chromium environments were needed for testing, the alumina cell fixtures were placed inside of a quartz tube that was closed off with a silicon-rubber plug containing an inlet and outlet rod for gas flow. This way specific testing environments could be meticulously tailored for each cell stack in the furnace

Chromium species were introduced to the symmetrical cells during testing by placing a Cr source (chromia forming interconnect material) in close proximity with each air electrode of the cell. These Cr sources were either annealed Crofer 22 (Cr22), uncoated interconnect material, or a coated interconnect material. Annealed Cr22 is a common chromia forming interconnect material used in commercial fuel cell operation. Interconnect material was used to be able to adequately confirm that the PCO infiltration would resist chromia deposition from various possible interconnect materials. Interconnect material is often coated in commercial use to prevent some of the chromia species migration, a coated interconnect material was also tested to represent a more realistic operation of the cells. The uncoated interconnect and Cr22 Cr sources offer an exacerbated Cr test to show cell stability in a shorter amount of time. These accelerated stability tests were performed because fuel cells often have a lifetime in commercial use of more than 50,000 hours.

### Example 8—Single Cell Testing Procedure

The single cells were mounted on an alumina supporting tube by Ceramabond 552 (Aremco) for electrochemical performance testing. For the fuel cell test, 20 mL/min humidified H₂ (3% H₂O) was supplied to the fuel electrode as the fuel while ambient air at the air electrode was used as the oxidant. Gas chromatography was used to monitor the hydrogen concentration in the fuel electrode, which was used to calculate the amount of actual hydrogen generated.

### Example 9—PCO Phase Confirmation

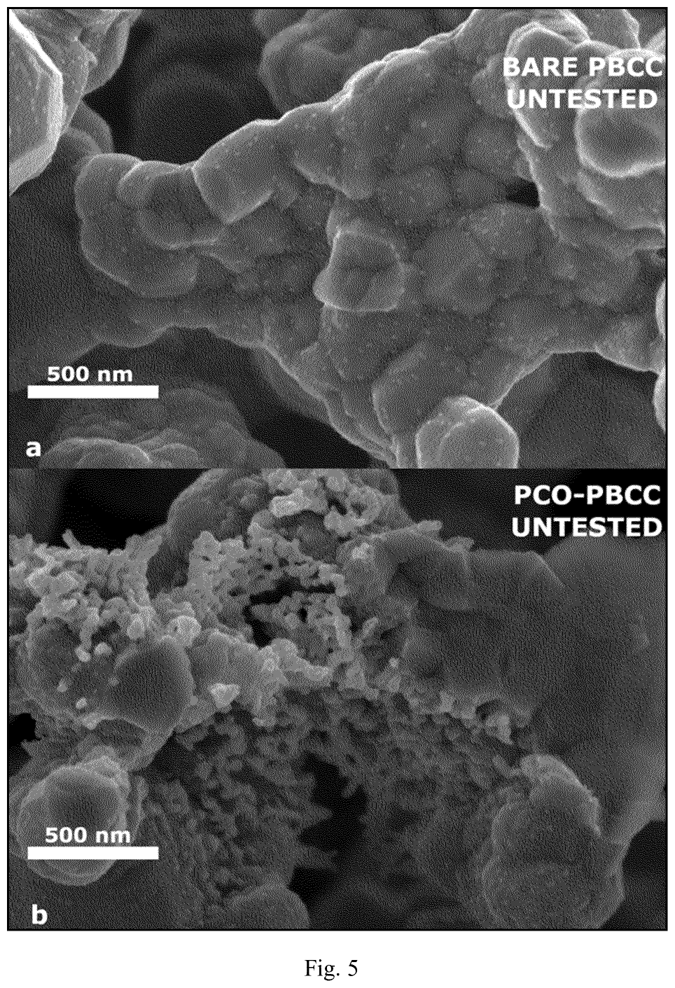

XRD was used to gain further understanding of the PCO infiltration before testing was conducted. The XRD analysis of the PCO powder combusted at 800° C. is shown in FIG. 4. Using the Highscore software, a match was found to the PCO powder as being of the cubic crystal system and space group Pm-3m. XRD confirmed formation of single phase PCO. It was attempted to infiltrate a large amount of PCO solution into PBCC to understand if there were new phases formed from infiltration, but this was inconclusive and the XRD from this infiltrated powder was the same as pure PBCC powder. Instead, the as-synthesized powder was the closest estimation of the phase formation from infiltration on the PBCC backbone that was obtained.

### Example 10—Symmetrical Cell Testing Results

Symmetrical cells were tested for long term stability against high steam and Cr contaminants to isolate the PBCC air electrodes polarization resistance (Rₚ). The Rₚ of a symmetrical cell is generally accepted to be dependent on the air electrode performance, while the ohmic resistance of a cell is generally accepted to be dependent on the electrolyte layer of the symmetrical cell. By measuring the differences in Rₚ of unmodified or “bare” PBCC-SDC symmetrical cells versus the cells infiltrated with various catalysts, the changes to Rₚ could be directly attributed to changes to the PBCC air electrode's electrochemical performance. Electrochemical impedance spectrometry (EIS) was used to measure the Rₚ of cells tested with a Solartron 1255 HF frequency response analyzer interfaced with an EG&G PAR potentiostat model 273A. An AC amplitude of 10 mV in the frequency range from 100 kHz to 0.02 Hz was used.

SDC was chosen as the electrolyte material for the PBCC symmetrical cells due to its excellent resistance to high humidity environments. While not inherently a proton conducting material, SDC was able to be implemented for these tests because the nonfunctional symmetrical cell's sole purpose is to isolate the performance of the PBCC air electrode in high steam environments by measuring changes in Rₚ. SDC offered stable performance and allowed all degradation of performance in high steam to be attributed to the PBCC air electrode component of the cell.

After optimization in a 30% steam environment, it was found that excellent performance could be achieved when 7.5 l of 0.2 M PrCoO₃ catalyst solution was deposited into the as-prepared PBCC backbone (electrode area 0.28 cm²) with a pipette. This allowed for a mass loading of 1.16 mg/cm²PrCoO₃ catalyst for each PBCC electrode of the symmetrical cell. The comparison between untreated bare PBCC and the infiltrated PBCC can be seen in FIG. 5. The particles on the surface of the bare PBCC are thought to be exsolved BaCoO₃ nanoparticles previously discovered to be in the PBCC system. However, it was found in this example that the nanoparticles would exsolve during fabrication of the symmetrical cells, despite the particle formation only previously thought to occur in the presence of steam. The PCO-PBCC cell has PCO infiltrate particle deposition on its surface. This deposition is abundant at the surface and occurs less toward the triple phase boundary of the cell.

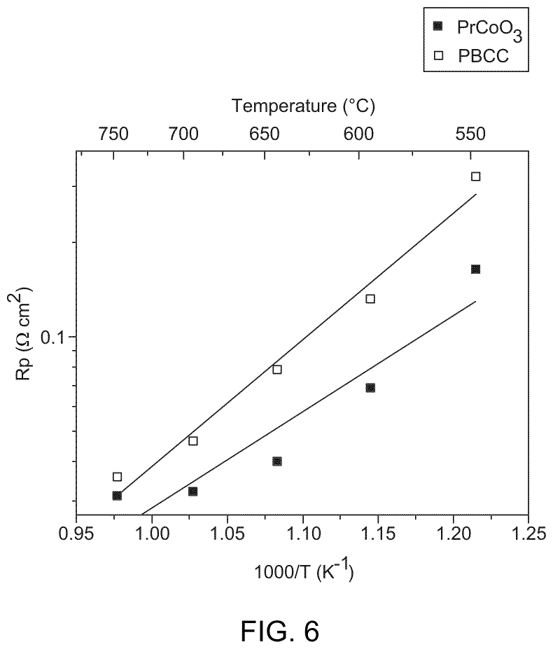

Activation energy tests were conducted on 1.16 mg/cm² infiltration cells and bare PBCC cells. The cells were measured between temperatures of 550-750° C. A plot of the activation energy is shown in FIG. 6. The bare cell exhibited an average activation energy of 0.80 eV while the PCO infiltrated cell demonstrated an activation energy of 0.61 eV. This was a promising sign that the PCO-PBCC cells would perform well at further reduced temperatures.

Infiltrated PCO-PBCC and bare PBCC symmetrical cells were tested against various Cr sources over more than 650 hours. During this time, the steam concentration being fed into the testing apparatus was adjusted from dry air to 3% steam to 10% steam and finally to 30% steam to better study the effect that each steam environment had on cell performance. The steam level was increased after cells began to show stable performance.

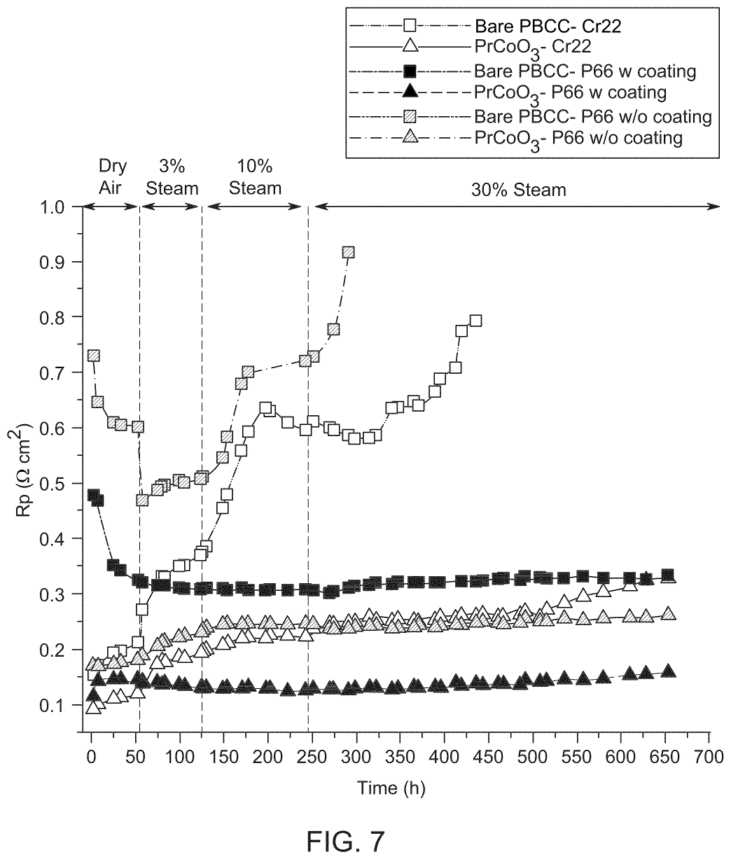

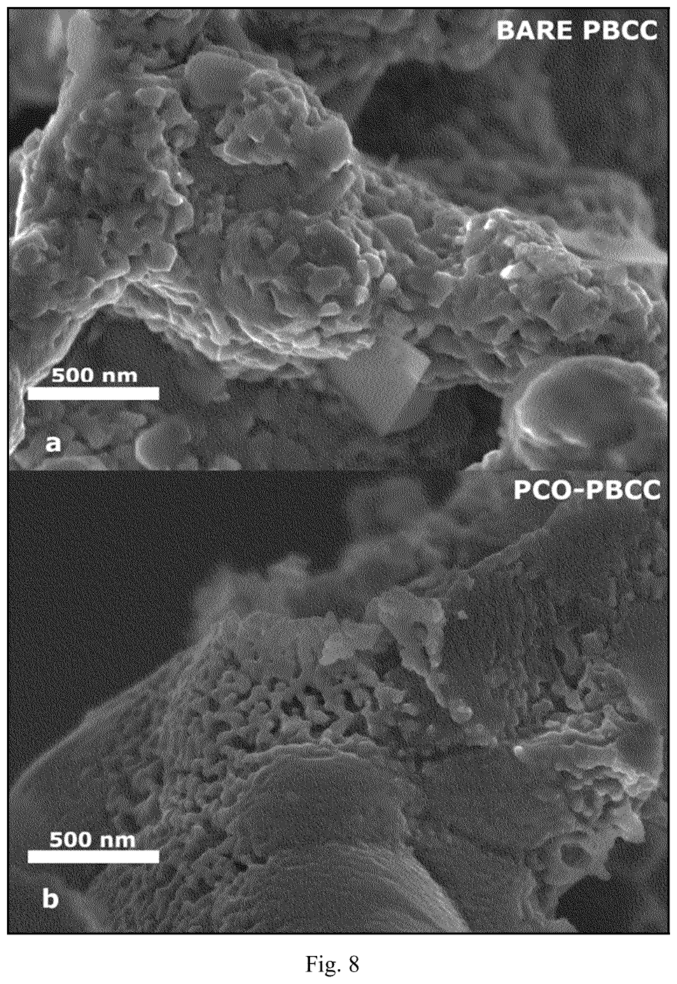

The total long term stability test of the bare cell and PCO-PBCC cells are shown in FIG. 7. The bare cells tested against both coated and uncoated interconnect Cr sources (P66 w coating and P66 w/o coating in the Figs.) experienced a large drop in their Rₚ after about 25 hours of testing. The bare cell tested against the uncoated P66 interconnect material showed a more extreme reaction to changing steam environments than other cells. The bare cell's Rₚ indicated unstable behavior at low steam concentrations, suffering from performance degradation of 42% over the 125 hrs in a 10% steam environment. The cell then suffered performance degradation so large that it could not be reliably calculated using EIS in less than 50 hrs exposed to 30% steam. This is the reason the polarization resistances of this cell were only shown for up to 291 hrs of testing. The 1.16 mg/cm² PCO infiltrated cell tested against this same backing demonstrated initial cell conditioning when exposed to 3% steam, but it then showed stable performance across the entirety of the test, regardless of steam content, after reaching a stable performance of 0.235 Ωcm² at the introduction of 10% steam. The PCO infiltrated cell that was tested against the uncoated interconnect showed only 11% degradation during 125 hrs exposure to 10% steam and 400 hrs exposure to 30% steam.

After 150 hrs of testing in 30% steam and 400 hrs total testing, the bare cell tested against Cr22 began to rapidly degrade in performance. At 485 hrs of testing, the cell's EIS results could not be reliably estimated and interpreted. The PCO-PBCC cell tested against the annealed Cr22 demonstrated far better stability than its bare cell counterpart. The cell showed slightly better performance than the PCO-PBCC cell tested against the uncoated interconnect until the steam was increased to 30% around 250 hrs testing. It was here that the performance began to worsen to 0.328 Ωcm² after 400 hrs tested in 30% steam.

The bare PBCC and PCO-PBCC cells showed excellent performance and stabilities across all steam levels when tested against the coated interconnect as a Cr source. This was expected as the coating on the interconnect material should limit most if not all the Cr migration from the material. Because PBCC was known to be stable in high steam environments, there were no mechanisms expected that would cause degradation to the cell in this testing environment. For the first 500 hrs of testing after a brief initial cell conditioning, the PCO-PBCC cell tested against the coated interconnect backing showed no degradation from an Rₚ of 0.147 Ωcm². In the same period, the bare PBCC cell tested against the same backing type demonstrated only a 3.3% degradation from a performance of 0.321 Ωcm²

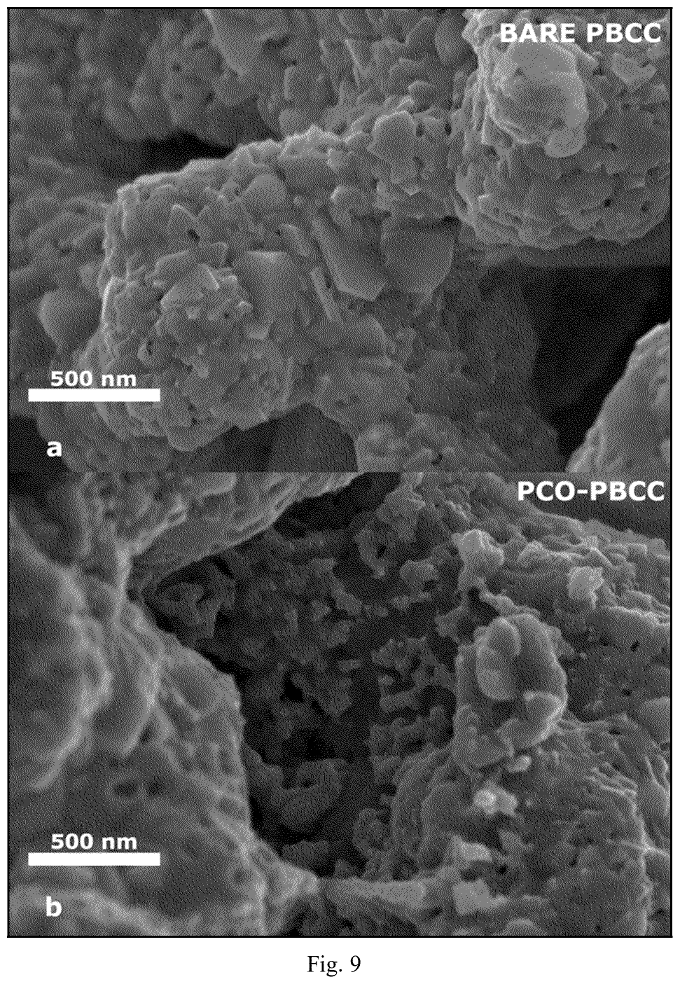

Scanning Electron Microscopy (SEM) imaging of the bare cells tested against the Cr22 and uncoated interconnect material showed that the cells' air electrodes were covered in deposition of a new faceted scaling particle structure on the surface of the PBCC. This structure appears to be chromia species deposition and was the most likely cause of the drastic performance degradation experienced by the cells. The deposition can be seen in FIG. 8(a) and FIG. 9(a). Images of the PCO infiltrated cells tested against these same Cr sources can be seen in FIG. 8(b) and FIG. 9(b). The cells had depositions of PCO infiltration that remained after testing. The areas with the PCO particle deposition remained free of chromia scaling. However, these cells still had areas covered in chromia scaling, which was an explanation for the degradation experienced over time. The PCO limiting some of the formation of the Cr species, especially on the surface of the PBCC, is the most likely cause for the improved cell stability offered by infiltration of PCO.

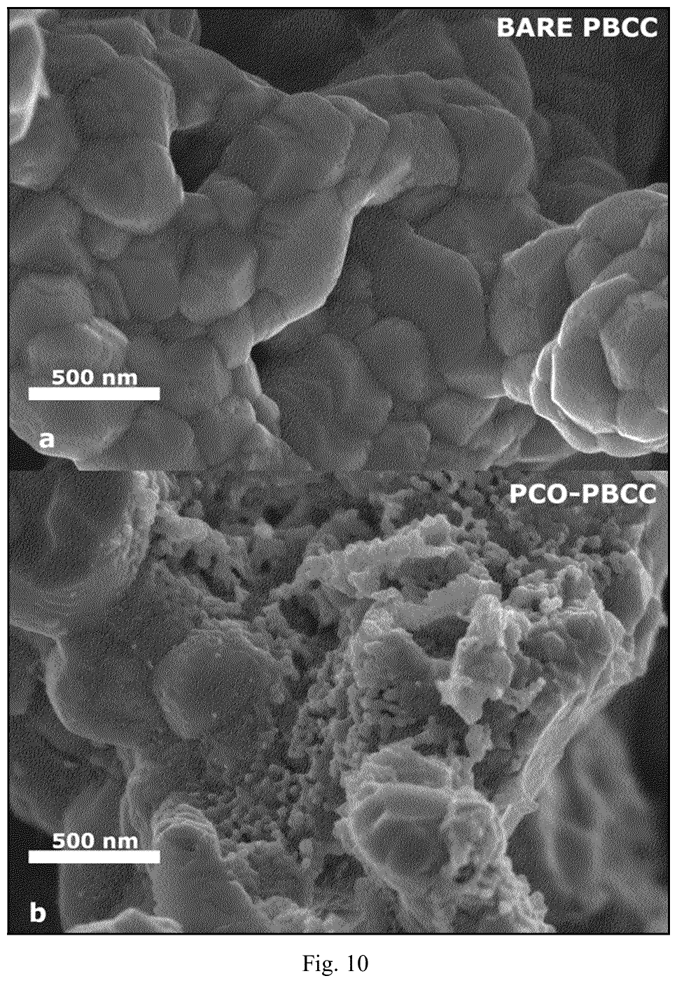

Images taken from the bare and infiltrated cells tested against the coated interconnect material revealed that the cells remained free of any chromia species deposition. FIG. 10(a) shows the bare PBCC cell tested against the coated interconnect material, which remained completely bare after 650 hrs of testing. FIG. 10(b) shows the PCO-PBCC cell, which had pockets of PCO particle deposition but no oxide scaling build up. Lack of chromia species deposition most likely allowed for the cells to show excellent stability over 650 hrs of total testing.

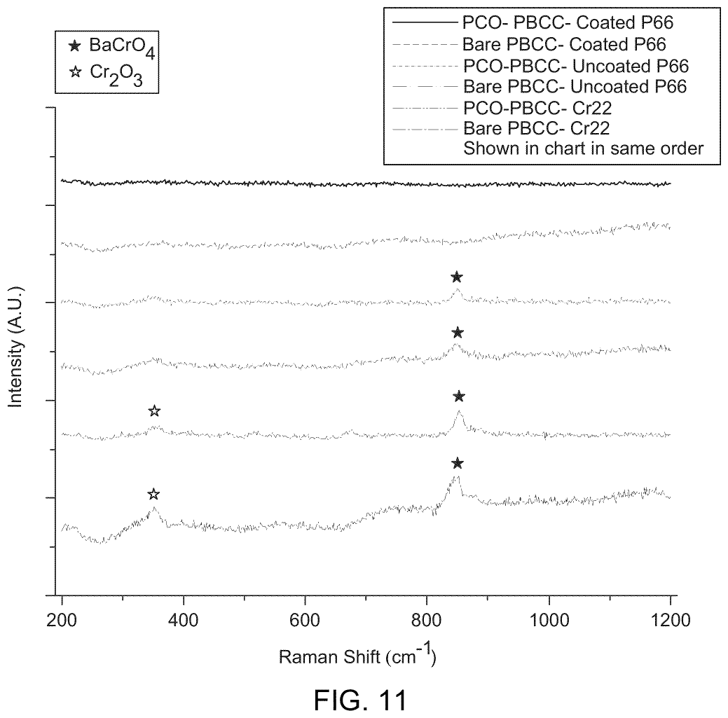

Raman spectroscopy results from all 6 cells tested confirmed the findings from the SEM images. Bare and infiltrated cells tested against both the Cr22 and the uncoated interconnect material both exhibit peaks corresponding to the presence of Cr₂O₃ and BaCrO₄. Both cells tested against the coated interconnect material exhibit no peaks, the expected result from pristine PBCC. No PCO peaks were observed as there is a low amount of infiltration in the cells, making the location of these species difficult to consistently find with Raman. The Raman spectra of these cells is shown in FIG. 11.

The composition of the scaling observed in SEM images from the tested symmetrical cells was confirmed by comparing it to images from literature detailing the CrO₃ and BaCrO₄ structures formed in the presence of Cr species. Cr species oxide scaling from Cr22, formation of chromium spinel on the surface of a SS430 alloy, and BaCrO₄ nanoparticle images from the literature were similar in appearance to the faceted scaling structure covering the PBCC surface in FIGS. 8(a) and 9(a). The similarities in appearance between chromia scaling and the scaling found of the tested cells, in combination with the Raman spectroscopy results confirming the existence of Cr₂O₃ and BaCrO₄ are strong evidence that the structure forming on the surface of the bare cells tested against Cr22 and uncoated interconnect are in fact Cr₂O₃ and BaCrO₄ species.

This variable steam test demonstrated that the PCO infiltration into the cell will greatly improve cell performance and stability across different steam levels and various methods of Cr species introduction.

### Example 11—Single Cell Testing Results

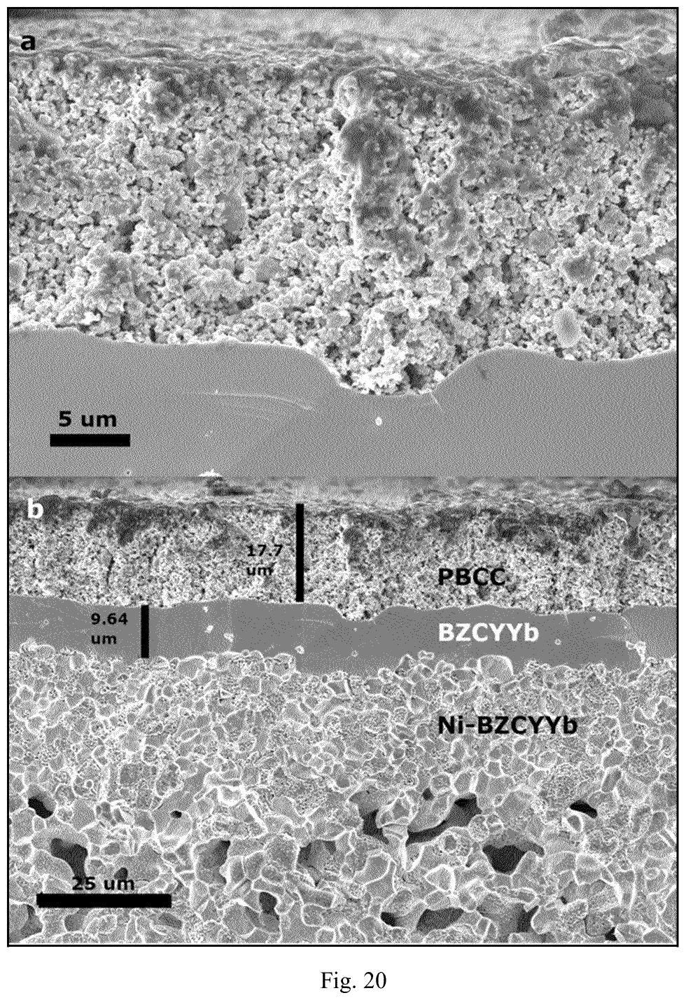

After the long-term stability test with PCO infiltrated PBCC using symmetrical cells, single cell tests were conducted to explore the use of PCO as a catalyst for P-rSOCs. PCO was infiltrated into the air electrode side of a Ni—BaZr_{0.1}Ce_{0.7}Y_{0.1}Yb_{0.1}O_{3-δ}|BZCYYb|PBCC single cell. The single cell had a thinner brush painted air electrode than the symmetrical cells. The air electrode thickness of the single cell was measured after firing to be 17.7 microns thick via SEM imaging (see FIG. 20(b)), which is less than ⅔ the thickness of the symmetrical cells PBCC thickness after firing. Due to this difference, a new approach to infiltration was taken. Rather than having one 7.5 μL load of 0.2 M PCO applied to the air electrode, 4 installments of 2 μL were applied. This allowed for a mass loading of 1.24 mg/cm² on the PBCC. After each of the first three loads were infiltrated into the backbone, a firing step to 400° C. for a 1 hr hold time was implemented. Then, after the last 2 μL infiltration, the cell was fired to 800° C. using a 2° C./min ramp rate for a 2 hrs hold time.

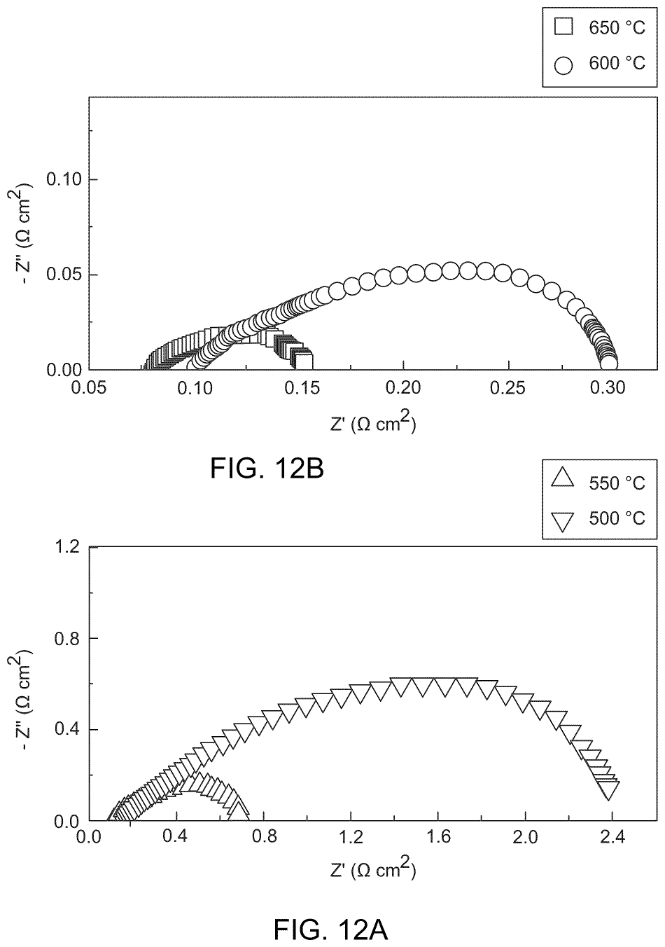

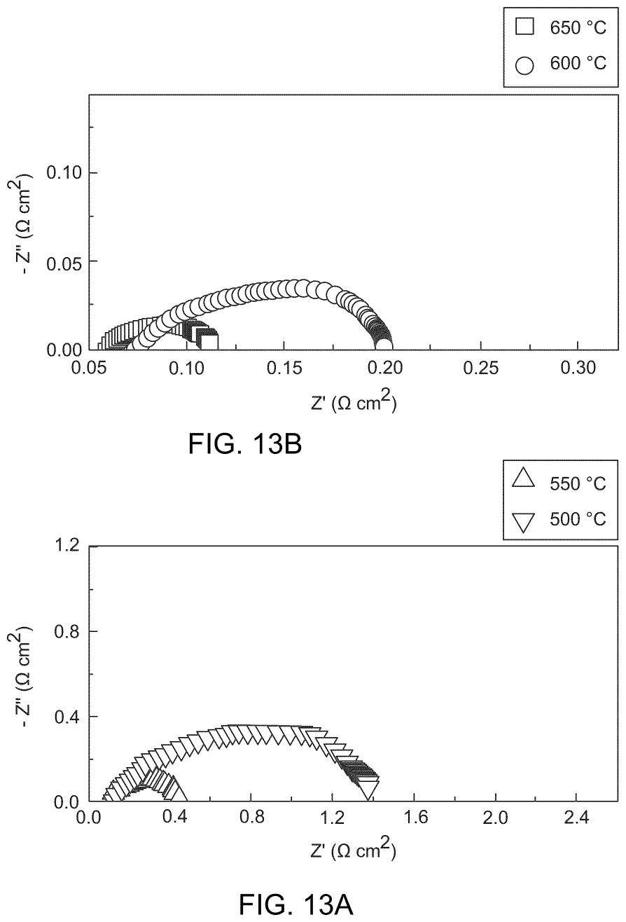

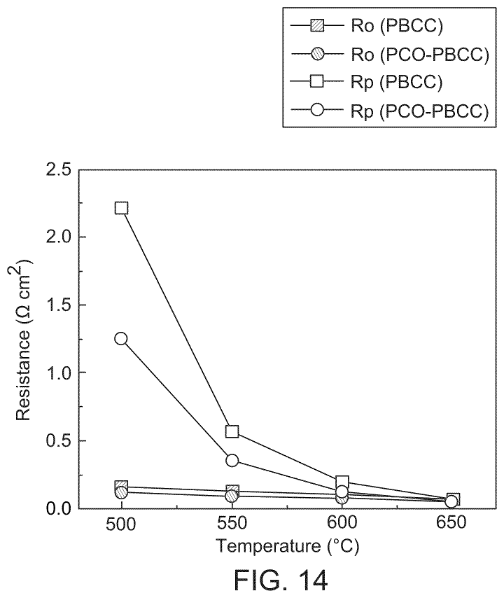

The infiltration yielded exceptional electrochemical performance from the single cell. EIS was taken for both the infiltrated and bare single cells. The EIS plots for the bare single cells are displayed in FIGS. 12A-12B. The EIS plots for the infiltrated cells are shown in FIGS. 13A-13B. At 600° C., the Rₚ of the bare cell was 0.197 Ωcm² while the infiltrated single cell demonstrated an Rₚ of 0.126 Ωcm². The EIS plots were not normalized to remove the ohmic resistance. The purpose of this was to emphasize that, in a functioning single cell, the infiltration of the catalyst strictly affects the Rₚ. This effect can be easily observed in FIG. 14. Here all the ohmic and polarization resistances for the bare and infiltrated cells at various temperatures can be observed. This figure illustrates that the largest decrease to Rₚ occurs at lower temperatures. This implies that infiltration techniques help to continue the decrease of operation temperatures of reversible proton conducting cells.

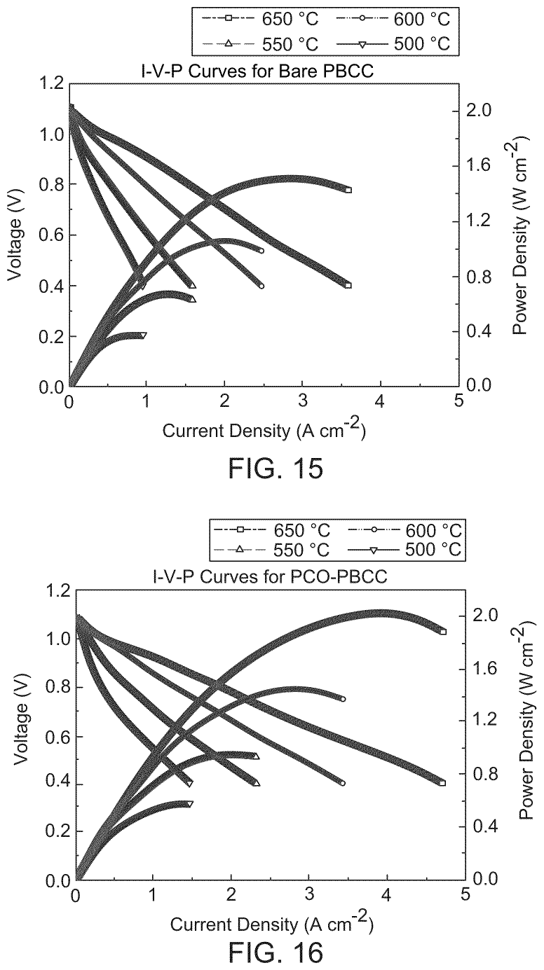

Voltage was applied, ranging from the open circuit voltage (OCV) of the cell to 0.4 V, and the corresponding current was monitored. The current reading was normalized for the area of the PBCC air electrode. From the voltage and corresponding current density, power density was calculated. The I-V-P curves of the bare PBCC and infiltrated single cells are displayed in FIGS. 15 and 16, respectively. The figures indicate that the peak power density of the bare PBCC cell at 650° C. was 1.49 W/cm². At the same temperature, the peak power density of PCO-PBCC was 2.02 W/cm², which is over a 35.5% improvement.

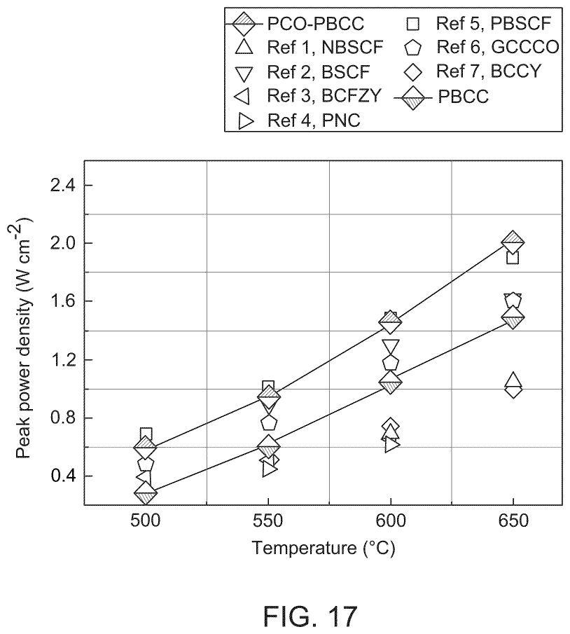

The peak power densities from a temperature range of 500-650° C. were plotted against peak power densities reported for certain leading conventional proton conducting rSOCs. This comparison is shown in FIG. 17. The results also allow for easy visualization of the enhanced performance of PCO-PBCC vs PBCC. Here it can be observed that the PCO-PBCC cell was among the best current performing proton conducting single cells.

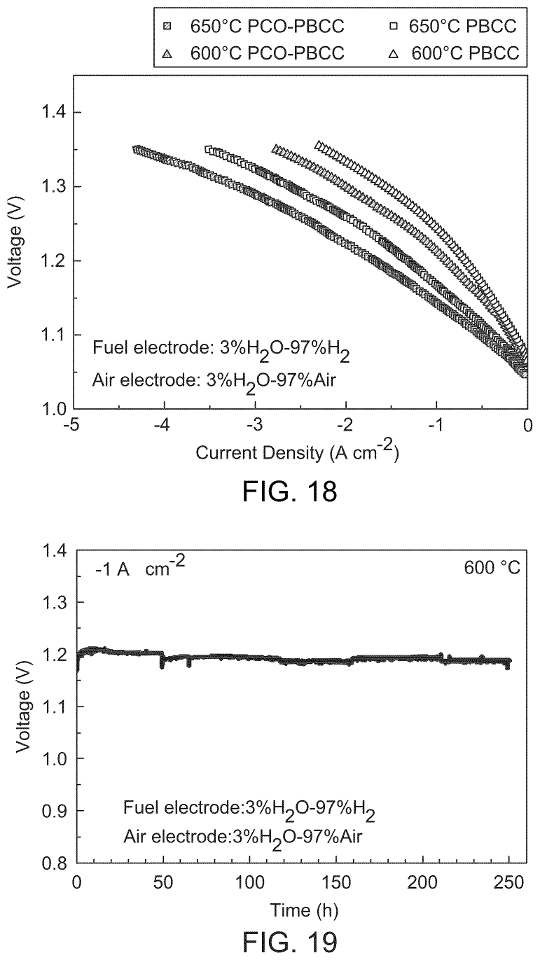

The infiltrated and bare single cells were then run in electrolysis mode at both 600° C. and 650° C. from a 1.35 voltage to OCV. The I-V curves from the test are recorded in FIG. 18. The curves were measured with 3% H₂O—97% H₂ at the fuel electrode and 3% H₂O—97% air at the air electrode. At 1.3 V the bare PBCC single cells demonstrated a current density of −2.63 A/cm² at 650° C. and −1.627 A/cm² at 600° C. The PCO-PBCC single cells demonstrated a current density of −3.22 A/cm² at 650° C. (a 22.4% improvement) and −1.99 A/cm² at 600° C. (a 22.3% improvement).

In electrolysis mode, the PCO-PBCC single cell also demonstrated excellent stability. The cell demonstrated negligible degradation at 600° C. when run at −1 A/cm². The stability is shown in FIG. 19.

An SEM investigation of the single cells was used to compare the morphological changes caused by the PCO infiltration to the PBCC bare cell. SEM imaging was also used to make observations about the contact of the various layers of the cell and to make measurements of the electrolyte and air electrode layer thickness. As mentioned previously, the average thickness of the PBCC air electrode layer was found to be 17.7 microns. The electrolyte layer was measured to have an average thickness of 9.64 microns. The measurements are illustrated in FIG. 20(b). FIG. 20(a) is a higher magnification image of the interface between the PBCC and the BZCYYb electrolyte. No delamination between the two layers was observed.

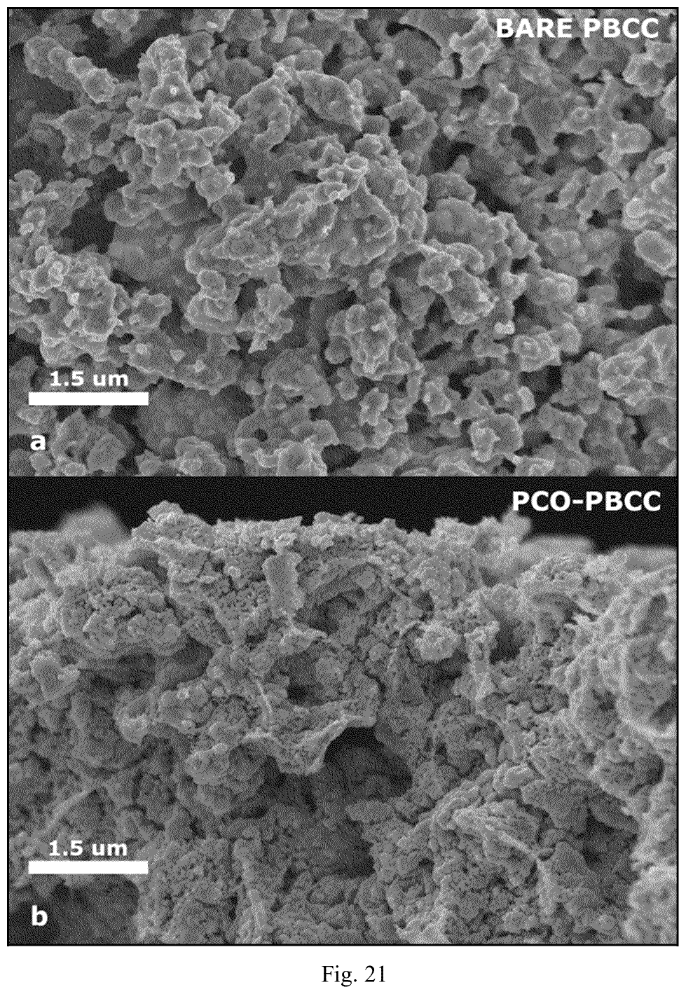

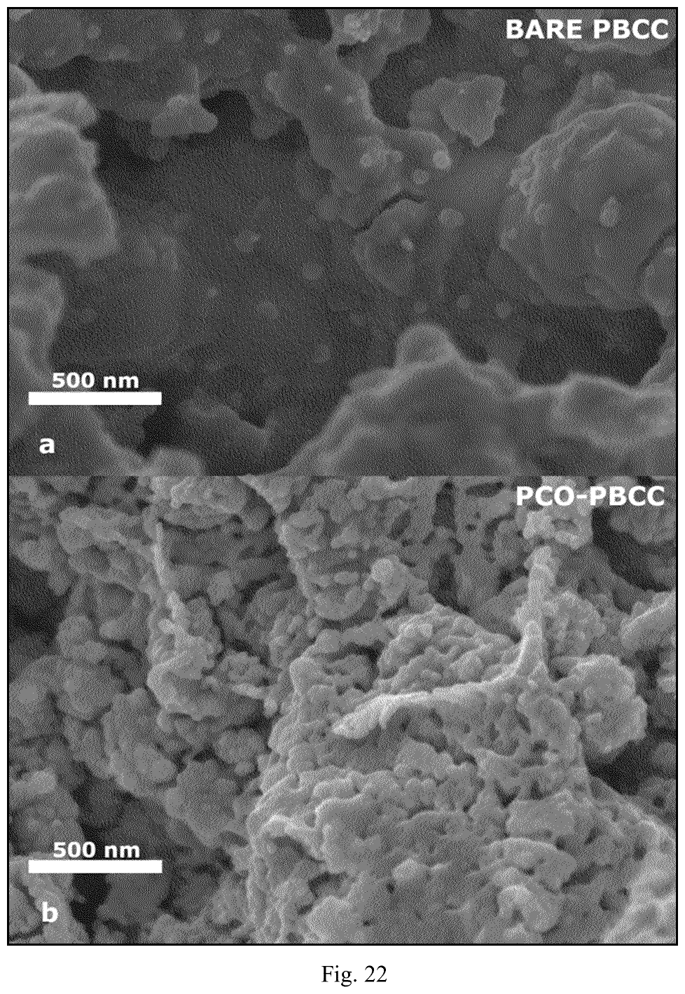

SEM imaging taken at higher magnification illustrated a stark difference between the surface morphology of the PCO-PBCC and bare PBCC single cell air electrodes. The difference is shown in FIGS. 21 and 22, which are taken at ×15k and ×50k magnification respectively. In the figures, it was observed that the PCO-PBCC formed a conformal-like coating of PCO deposition across almost the entirety of the PBCC backbone. This coating was much more consistent across the PBCC layer than had been achieved in the symmetrical cells. The deposition covering the PCO-PBCC is identical to that of earlier PCO infiltration found via SEM imaging, with the only exception being the quantity of deposition is larger. The near complete coverage of PCO infiltration across the backbone is the most likely reason for the excellent performance of the infiltrated single cells. This suggested that the multi load application of the PCO infiltration is highly effective.

### Example 12—Discussion of Results

The above work analyzed the enhancement of a high-performance reversible solid oxide cell based on proton-conducting electrolytes by liquid solution infiltration of a PrCoO₃ catalyst. The catalyst was infiltrated into the porous PBCC electrodes, an oxygen electrode material of high electrocatalytic activity with good resistance to steam and CO₂-containing environments. Symmetrical cells infiltrated with PrCoO₃ displayed substantial improvements in both electrocatalytic activity and stability when compared to bare PBCC cells. The improvements were especially noticeable when tested in environments with high concentration (30%) of steam in the presence of a Cr-containing alloy. In the tests, the bare PBCC oxygen electrode experienced the formation of BaCrO₄ on its surface in the presence of Cr contaminants, which has catastrophic effects on the polarization resistance of the cells. From SEM images, it was observed that formation of this chromia species is limited by the PrCoO₃ coating formed by infiltration into the porous PBCC electrodes.

When the PrCoO₃ solution was infiltrated into the porous PBCC oxygen electrode of a test cell with a configuration of Ni—BaZr_{0.1}Ce_{0.7}Y_{0.1}Yb_{0.1}O_{3-δ}|BZCYYb|PBCC, a peak power density of 2.02 W cm⁻² at 650° C. in fuel cell mode was achieved, representing a 35.5% increase in power output compared to the same cell without PrCoO₃ catalyst infiltration. When run in electrolysis mode, the same infiltrated single cells demonstrated a current density of 3.22 A/cm² at 650° C., corresponding to a 22.4% improvement in performance compared to the same cell without catalyst infiltration. While in electrolysis mode, the infiltrated single cells showed negligible degradation for 250 hours of testing. The reversible solid oxide cells with PrCoO₃ infiltrated PBCC oxygen electrode are among the best performing P-rSOCs reported in literature. PrCoO₃ was an impressive catalyst candidate for PBCC based P-rSOC cells.

Catalyst infiltration into a double perovskite oxide material at the oxygen electrode (e.g., PrBa_{0.8}Ca_{0.2}Co₂O_{5+δ} (PBCC)) using a PrCoO₃ (PCO) catalyst solution offers a possible solution to the problems of sluggish ORR and OER reactions and degradation experienced under the harsh conditions of the oxygen electrode. Symmetrical cells using a PBCC oxygen electrode infiltrated with a PCO catalyst demonstrated particularly excellent stability and electrochemical performance (with a polarization resistance as low as 0.147 Ωcm² and minimal degradation over 500 hours) against various sources of Cr contaminations at steam concentrations as high as 30% at 600° C. Single cells infiltrated with PrCoO₃ exhibited a peak power density of 2.02 W/cm² at 650° C. in fuel cell mode, a 35.5% increase in performance from the single cells without catalyst modification. When run in electrolysis mode the same infiltrated single cells demonstrated a current density of 3.22 A/cm² at 650° C., a 22.4% improvement from the performance of the cells without catalyst modification. The single cell based on a PCO infiltrated cathode was among the best performing P-rSOCs ever reported.

### ILLUSTRATIVE EMBODIMENTS

The following is a description of various embodiments of the disclosed subject matter. Each embodiment may include one or more of the various features, characteristics, or advantages of the disclosed subject matter. The embodiments are intended to illustrate a few aspects of the disclosed subject matter and should not be considered a comprehensive or exhaustive description of all possible embodiments.

P1. A solid oxide cell comprising any combination of one or more of the following: a fuel electrode; an oxygen electrode; and an electrolyte positioned between the fuel electrode and the oxygen electrode; wherein the oxygen electrode includes a perovskite oxide material coated with a catalyst; wherein the electrolyte is a proton conducting electrolyte; and wherein the solid oxide cell is a reversible solid oxide cell.

P2. The solid oxide cell of paragraph P1 wherein the catalyst includes a single perovskite oxide material comprising praseodymium and cobalt.

P3. The solid oxide cell of any one of paragraphs P1 to P2 wherein the catalyst includes Pr₁₋ₓCo_{1-y}O₃ where x and y are non-integer values between 0 and 1.

P4. The solid oxide cell of any one of paragraphs P1 to P3 wherein the perovskite oxide material is a double perovskite oxide material.

P5. The solid oxide cell of any one of paragraphs P1 to P4 wherein the perovskite oxide material is a double perovskite oxide material comprising praseodymium, barium, cobalt, and at least one of calcium or niobium.

P6. The solid oxide cell of any one of paragraphs P1 to P5 wherein the solid oxide cell has a peak power density of at least 1.6 W/cm² at 650° C. in fuel cell mode.

P7. The solid oxide cell of any one of paragraphs P1 to P6 wherein the solid oxide cell includes a single solid oxide cell where the absolute value of a current density is at least 2.9 A/cm² at 1.3 V and 650° C. in electrolysis mode.

P8. The solid oxide cell of any one of paragraphs P1 to P7 wherein the oxygen electrode operated in electrolysis mode for at least 250 hours experiences negligible degradation.

P9. The solid oxide cell of any one of paragraphs P1 to P8 wherein the electrolyte has a formula of ABO_{3+δ} where one or more alkaline earth metals are in the A sites and one or more transition metals or rare earth metals are in the B sites.

P10. The solid oxide cell of any one of paragraphs P1 to P9 wherein the electrolyte has a formula of BaZr_{w}CeₓY_{y}Yb_{z}O_{3-δ} where w+x+y+z=approximately 0.75 to approximately 1.

P11. The solid oxide cell of any one of paragraphs P1 to P10 wherein the electrolyte has a formula of BaZr_{0.1}Ce_{0.7}Y_{0.1}Yb_{0.1}O_{3-δ}.

P12. A solid oxide cell comprising any combination of one or more of the following: a fuel electrode; an oxygen electrode having a formula of Pr_{w}BaₓCa_{y}Co_{z}O_{5+δ} or Pr_{w}BaₓCo_{y}Nb_{z}O_{5+δ} where w+x+y+z=approximately 4; and an electrolyte positioned between the fuel electrode and the oxygen electrode; wherein the oxygen electrode is coated with a catalyst.

P13. The solid oxide cell of paragraph P12 wherein the catalyst includes Pr₁₋ₓCo_{1-y}O₃ where x and y are non-integer values between 0 and 1.

P14. The solid oxide cell of any one of paragraphs P12 to P13 wherein the solid oxide cell is a reversible solid oxide cell.

P15. The solid oxide cell of any one of paragraphs P12 to P14 wherein the electrolyte is a proton conducting electrolyte.

P16. The solid oxide cell of any one of paragraphs P12 to P15 wherein the electrolyte has a formula of ABO_{3+δ} where one or more alkaline earth metals are in the A sites and one or more transition metals or rare earth metals are in the B sites.

P17. The solid oxide cell of any one of paragraphs P12 to P16 wherein the electrolyte has a formula of BaZr_{w}CeₓY_{y}Yb_{z}O_{3-δ} where w+x+y+z=approximately 0.75 to approximately 1.

P18. The solid oxide cell of any one of paragraphs P12 to P17 wherein the electrolyte has a formula of BaZr_{0.1}Ce_{0.7}Y_{0.1}Yb_{0.1}O_{3-δ}.

P19. The solid oxide cell of any one of paragraphs P12 to P18 wherein the solid oxide cell has a peak power density of at least 1.6 W/cm² at 650° C. in fuel cell mode.

P20. The solid oxide cell of any one of paragraphs P12 to P19 wherein the solid oxide cell includes a single solid oxide cell where the absolute value of a current density is at least 2.9 A/cm² at 1.3 V and 650° C. in electrolysis mode.

P21. A method comprising any combination of one or more of the following: infiltrating a solid oxide cell (SOC) electrode with a first solution including a catalyst to form a first infiltrated material; heating the first infiltrated material to form a dry SOC material; infiltrating the dry SOC material with a final solution including a catalyst to form a final infiltrated material; and heating the final infiltrated material to form an infiltrated solid oxide cell electrode.

P22. The method of paragraph P21 wherein the dry SOC material is a first dry SOC material, the method comprising any combination of one or more of the following: infiltrating the first dry SOC material with a second solution including a catalyst to form a second infiltrated material; heating the second infiltrated material to form a second dry SOC material; and infiltrating the second dry SOC material with the final solution to form the final infiltrated material.

P23. The method of paragraph P22 comprising any combination of one or more of the following: infiltrating the second dry SOC material with a third solution including a catalyst to form a third infiltrated material; heating the third infiltrated material to form a third dry SOC material; and infiltrating the third dry SOC material with the final solution to form the final infiltrated material.

P24. The method of any one of paragraphs P21 to P23 wherein the first solution and the second solution are the same solution.

P25. The method of any one of paragraphs P21 to P24 wherein the catalyst includes Pr₁₋ₓCo_{1-y}O₃ where x and y are non-integer values between 0 and 1.

P26. The method of any one of paragraphs P21 to P25 wherein the solid oxide cell electrode comprises a double perovskite oxide material.

P27. The method of any one of paragraphs P21 to P26 wherein the solid oxide cell electrode comprises a perovskite oxide material including a rare earth metal, an alkaline earth metal, and a transition metal.

P28. The method of any one of paragraphs P21 to P27 wherein the solid oxide cell electrode comprises a perovskite oxide material including praseodymium, barium, and cobalt.

P29. The method of any one of paragraphs P26 to P28 wherein the perovskite oxide material includes at least one of calcium or niobium.

P30. The method of any one of paragraphs P21 to P29 wherein the solid oxide cell electrode has a formula of Pr_{w}BaₓCa_{y}Co_{z}O_{5+δ} or Pr_{w}BaₓCo_{y}Nb_{z}O_{5+δ} where w+x+y+z=approximately 4.

P31. The method of any one of paragraphs P21 to P30 wherein the solid oxide cell electrode has a formula of: PrBaₓCa_{y}Co₂O_{5+δ} where x+y=approximately 1; or PrBaₓCo_{y}Nb_{z}O_{5+δ} where x=approximately 0.75 to approximately 1 and y+z=approximately 1.

P32. The method of any one of paragraphs P21 to P31 wherein the solid oxide cell electrode has a formula of PrBa_{0.8}Ca_{0.2}Co₂O_{5+δ} or PrBa_{0.9}Co_{1.96}Nb_{0.04}O₅.

P33. The method of any one of paragraphs P21 to P32 wherein the first infiltrated material is positioned in a heated environment having a temperature of at least approximately 100° C., at least approximately 200° C., or at least approximately 300° C. to form the dry SOC material.

P34. The method of any one of paragraphs P21 to P33 wherein the first infiltrated material is positioned in a heated environment having a temperature of approximately 100° C. to approximately 700° C., approximately 200° C. to approximately 600° C., or approximately 300° C. to approximately 500° C. to form the dry SOC material.

P35. The method of any one of paragraphs P21 to P34 wherein the first infiltrated material is positioned in a heated environment for at least approximately 20 minutes, at least approximately 30 minutes, at least approximately 40 minutes, or at least approximately 50 minutes to form the dry SOC material.

P36. The method of any one of paragraphs P21 to P35 wherein the final infiltrated material is positioned in a heated environment having a temperature of at least approximately 500° C., at least approximately 600° C., or at least approximately 700° C. to form the infiltrated solid oxide cell material.

P37. The method of any one of paragraphs P21 to P36 wherein the final infiltrated material is positioned in a heated environment having a temperature of approximately 500° C. to approximately 1100° C., approximately 600° C. to approximately 1000° C., or approximately 700° C. to approximately 900° C. to form the infiltrated solid oxide cell material.

P38. The method of any one of paragraphs P21 to P37 wherein the final infiltrated material is positioned in an environment heated at a rate of at least approximately 1° C./min, at least approximately 1.5° C./min, at least approximately 1.7° C./min, or at least approximately 1.9° C./min.

P39. The method of any one of paragraphs P21 to P38 wherein the final infiltrated material is positioned in an environment heated at a rate of approximately 1° C./min to approximately 10° C./min, approximately 1.5° C./min to approximately 6° C./min, approximately 1.7° C./min to approximately 4° C./min, or approximately 1.9° C./min to approximately 3° C./min.

P40. The method of any one of paragraphs P21 to P39 wherein the final infiltrated material is positioned in an environment heated at a rate of no more than approximately 10° C./min, no more than approximately 6° C./min, no more than approximately 4° C./min, or no more than approximately 3° C./min.

P41. The method of any one of paragraphs P21 to P40 wherein the final infiltrated material is positioned in a heated environment for at least approximately 80 minutes, at least approximately 90 minutes, at least approximately 100 minutes, or at least approximately 110 minutes to form the infiltrated solid oxide cell material.

P42. The method of any one of paragraphs P21 to P41 wherein vacuum infiltration is used to infiltrate at least one of the SOC electrode with the first solution or the dry SOC material with the final solution.

P43. A method comprising any combination of one or more of the following: infiltrating a solid oxide cell electrode with a catalyst, the solid oxide cell electrode including a double perovskite oxide material; wherein the double perovskite oxide material includes praseodymium, barium, and cobalt.

P44. The method of paragraph P43 wherein the catalyst includes Pr₁₋ₓCo_{1-y}O₃ where x and y are non-integer values between 0 and 1.

P45. The method of any one of paragraphs P43 to P44 wherein the double perovskite oxide material includes at least one of calcium or niobium.

P46. The method of any one of paragraphs P43 to P45 wherein the double perovskite oxide material has a formula of Pr_{w}BaₓCa_{y}Co_{z}O_{5+δ} or Pr_{w}BaₓCo_{y}Nb_{z}O_{5+δ} where w+x+y+z=approximately 4.

P47. The method of any one of paragraphs P43 to P46 wherein the double perovskite oxide material has a formula of: PrBaₓCa_{y}Co₂O_{5+δ} where x+y=approximately 1; or PrBaₓCo_{y}Nb_{z}O_{5+δ} where x=0.75 to 1 and y+z=approximately 1.

P48. The method of any one of paragraphs P43 to P47 wherein the double perovskite oxide material has a formula of PrBa_{0.8}Ca_{0.2}Co₂O_{5+δ} or PrBa_{0.9}Co_{1.96}Nb_{0.04}O₅.

### General Terminology and Interpretative Conventions

Any methods described in the claims or specification should not be interpreted to require the steps to be performed in a specific order unless expressly stated otherwise. Also, the methods should be interpreted to provide support to perform the recited steps in any order unless expressly stated otherwise.

Certain features described in the context of separate embodiments can also be implemented in combination in a single embodiment. Conversely, various features that are described in the context of a single embodiment can also be implemented in multiple embodiments separately or in any suitable subcombination. Moreover, although features may be described above in certain combinations and even initially claimed as such, one or more features from a claimed combination can be excised from the combination, and the claimed combination may be directed to a subcombination or variation of a subcombination.

The example configurations described in this document do not represent all the examples that may be implemented or that are within the scope of the claims. The term “example” shall be interpreted to mean “serving as an example, instance, or illustration,” and not “preferred” or “advantageous over other examples.”

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The phrase “based on” shall be interpreted to refer to an open set of conditions unless unequivocally stated otherwise (e.g., based on only a given condition). For example, a step described as being based on a given condition may be based on the recited condition and one or more unrecited conditions.

The terms have, having, contain, containing, include, including, and characterized by should be interpreted to be synonymous with the terms comprise and comprising—i.e., the terms are inclusive or open-ended and do not exclude additional unrecited subject matter. The use of these terms should also be understood as disclosing and providing support for narrower alternative embodiments where these terms are replaced by “consisting of,” “consisting of the recited subject matter plus impurities and/or trace amounts of other materials,” or “consisting essentially of.”

Unless otherwise indicated, all numbers or expressions, such as those expressing dimensions, physical characteristics, or the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and/or by applying ordinary rounding techniques.

All disclosed ranges are to be understood to encompass and provide support for claims that recite any subranges or any individual values subsumed by each range. For example, a stated range of 1 to 10 should be considered to include and provide support for claims that recite any subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth), which values can be expressed alone or as a minimum value (e.g., at least 5.8) or a maximum value (e.g., no more than 9.9994).

All disclosed numerical values are to be understood as being variable from 0-100% in either direction and thus provide support for claims that recite such values (either alone or as a minimum or a maximum—e.g., at least <value> or no more than <value>) or any ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range expressed individually (e.g., 15.2), as a minimum value (e.g., at least 4.3), or as a maximum value (e.g., no more than 12.4).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

None of the limitations in the claims should be interpreted as invoking 35 U.S.C. 112(f) unless the words “means for” or “step for” are explicitly recited in the claim.

Unless explicitly stated otherwise or otherwise apparent from context, terms such as “processing,” “computing,” “calculating,” “determining,” “displaying,” or the like, refer to the action and processes of an electronic computing device including a processor and memory.

The subject matter recited in the claims is not coextensive with and should not be interpreted to be coextensive with any embodiment, feature, or combination of features described or illustrated in this document. This is true even if only a single embodiment of the feature or combination of features is illustrated and described.

Composition Related Terminology and Interpretative Conventions

Values expressed as a percentage, parts of, or a ratio are by weight unless expressly stated otherwise.

The description of a group or class of materials as suitable or preferred for a given purpose shall be understood as disclosing that a single member of the group or class or a mixture/combination of any two or more members of the group or class are equally suitable or preferred.

The description of constituents in chemical terms refers to the constituents: (a) at the time of addition to any combination specified in the description and/or (b) generated in situ by chemical reactions with other constituents. The description of the constituents does not preclude other chemical interactions among the constituents of a mixture once mixed unless expressly stated otherwise.

The description of materials in ionic form additionally implies the presence of sufficient counter ions to produce electrical neutrality for the composition.

### INCORPORATION BY REFERENCE

The entire content of each document listed below is incorporated by reference into this document (the documents below are collectively referred to as the “incorporated documents”). If the same term is used in both this document and one or more of the incorporated documents, then it should be interpreted to have the broadest meaning imparted by any one or combination of these sources unless the term has been explicitly defined to have a different meaning in this document. If there is an inconsistency between any incorporated document and this document, then this document shall govern. The incorporated subject matter should not be used to limit or narrow the scope of the explicitly recited or depicted subject matter.

Priority patent documents incorporated by reference:
U.S. Prov. App. No. 63/374,296, titled “Solid Oxide Cell,” filed on 1 Sep. 2022.

What is claimed is:

1. A solid oxide cell comprising:
a fuel electrode;
an oxygen electrode; and
an electrolyte positioned between the fuel electrode and the oxygen electrode;
wherein the oxygen electrode includes a perovskite oxide material coated with a catalyst;
wherein the electrolyte is a proton conducting electrolyte; and
wherein the solid oxide cell is a reversible solid oxide cell.

2. The solid oxide cell of claim 1 wherein the catalyst includes Pr₁₋ₓCo_{1-y}O₃ where x and y are non-integer values between 0 and 1.

3. The solid oxide cell of claim 1 wherein the perovskite oxide material is a double perovskite oxide material.

4. The solid oxide cell of claim 1 wherein the solid oxide cell electrode has a formula of Pr_{w}BaₓCa_{y}Co_{z}O_{5+δ} or Pr_{w}BaₓCo_{y}Nb_{z}O_{5+δ} where w+x+y+z=approximately 4.

5. The solid oxide cell of claim 1 wherein the solid oxide cell has a peak power density of at least 1.6 W/cm² at 650° C. in fuel cell mode.

6. The solid oxide cell of claim 1 wherein the solid oxide cell includes a single solid oxide cell where the absolute value of a current density is at least 2.9 A/cm² at 1.3 V and 650° C. in electrolysis mode.

7. The solid oxide cell of claim 1 wherein the oxygen electrode is configured to operate in electrolysis mode for at least 250 hours and experience negligible degradation.

8. The solid oxide cell of claim 1 wherein the electrolyte has a formula of ABO₃+₆ where one or more alkaline earth metals are in the A sites and one or more transition metals or rare earth metals are in the B sites.

9. The solid oxide cell of claim 1 wherein the electrolyte has a formula of BaZr_{w}CeₓY_{y}Yb_{z}O_{3-δ} where w+x+y+z=approximately 0.75 to approximately 1.

10. A solid oxide cell comprising:
a fuel electrode;
an oxygen electrode having a formula of Pr_{w}BaₓCa_{y}Co_{z}O_{5+δ} or Pr_{w}BaₓCo_{y}Nb_{z}O_{5+δ} where w+x+y+z=approximately 4; and
an electrolyte positioned between the fuel electrode and the oxygen electrode;
wherein the oxygen electrode is coated with a catalyst.

11. The solid oxide cell of claim 10 wherein the catalyst includes Pr₁₋ₓCo_{1-y}O₃ where x and y are non-integer values between 0 and 1.

12. The solid oxide cell of claim 10 wherein the solid oxide cell is a reversible solid oxide cell.

13. The solid oxide cell of claim 10 wherein the electrolyte is a proton conducting electrolyte.

14. The solid oxide cell of claim 10 wherein the electrolyte has a formula of BaZr_{w}CeₓY_{y}Yb_{z}O_{3-δ} where w+x+y+z=approximately 0.75 to approximately 1.

15. A method comprising:
infiltrating a solid oxide cell (SOC) electrode with a first solution including a catalyst to form a first infiltrated material;
heating the first infiltrated material to form a dry SOC material;
infiltrating the dry SOC material with a final solution including a catalyst to form a final infiltrated material; and
heating the final infiltrated material to form an infiltrated solid oxide cell electrode.

16. The method of claim 15 wherein the catalyst includes Pr₁₋ₓCo_{1-y}O₃ where x and y are non-integer values between 0 and 1.

17. The method of claim 15 wherein the solid oxide cell electrode has a formula of Pr_{w}BaₓCa_{y}Co_{z}O_{5+δ} or Pr_{w}BaₓCo_{y}Nb_{z}O_{5+δ} where w+x+y+z=approximately 4.

18. The method of claim 15 wherein the first infiltrated material is positioned in a heated environment having a temperature of at least approximately 100° C.

19. The method of claim 15 wherein the final infiltrated material is positioned in a heated environment having a temperature of at least approximately 500° C.
